(19) United States
(12) Patent Application Publication
(10) Pub. No.: US 2026/0281644 A1
(43) Pub. Date: Sep. 17, 2026

(54) INFORMATION PROCESSING APPARATUS AND METHOD, ENCODING APPARATUS, AUDIO REPRODUCING APPARATUS, AND PROGRAM

(71) Applicant: Sony Group Corporation, Tokyo (JP)

(72) Inventors: Akifumi Kono, Tokyo (JP); Tomonori Kawakami, Kanagawa (JP)

(73) Assignee: Sony Group Corporation, Tokyo (JP)

(21) Appl. No.: 18/996,361

(22) PCT Filed: Jul. 10, 2023
(86) PCT No.: PCT/JP2023/025402

§ 371 Date: Nov. 17, 2025

(30) Foreign Application Priority Data
Jul. 25, 2022 (JP) 2022-117760

(51) Int. Cl. H04S 7/00; G10L 19/008; G10L 19/035

(52) U.S. Cl. CPC H04S 7/30; G10L 19/008; G10L 19/035; H04S 7/40; H04S 2400/11

(57) ABSTRACT

The present technology relates to an information processing apparatus and method, an encoding apparatus, an audio reproducing apparatus, and a program that enable content to be produced in a shorter time.

An information processing apparatus includes a masking information calculation unit that calculates an auditory masking amount at each frequency of a target object with other objects as an inter-object masking frequency characteristic on the basis of a frequency spectrum and object position information of the target object and the frequency spectrum and the object position information of the other objects different from the target object, and a display control unit that displays the frequency spectrum of the target object and the inter-object masking frequency characteristic. The present technology can be applied to an information processing apparatus.

### TECHNICAL FIELD

The present technology relates to an information processing apparatus and method, an encoding apparatus, an audio reproducing apparatus, and a program, and relates more particularly to an information processing apparatus and method, an encoding apparatus, an audio reproducing apparatus, and a program capable of producing content in a shorter time.

### BACKGROUND ART

3D audio can provide a new music experience in which sound is heard from all directions of 360 degrees, which is different from conventional 2-ch audio. In particular, in object audio which is one of 3D audio formats, various sounds can be expressed by arranging a sound source called an audio object (hereinafter, also simply referred to as an object) at any position in a space.

In order to further spread the 3D audio, it is required to create a lot of pieces of high-quality content. In this regard, mixing work, that is, the work of determining a three-dimensional position and a gain of each of the objects is important. There are people called mixing engineers who specialize in such mixing work.

An example of a method for producing 3D audio content will be described below.

First, a mixing engineer receives, for example, audio data of each instrument, sound effect, or the like, such as a kicking object, a base object, or a vocal object, separately for each object.

Next, the mixing engineer listens to sounds of the entire content and each object. At this time, the mixing engineer analyzes, for example, the type of content such as genre and tone, the type of each object such as musical instrument type, and sound features of each object such as rising and duration.

Then, on the basis of analysis results thereof, the mixing engineer determines a position and a gain when each object is arranged in a three-dimensional space. Therefore, even among objects of the same instrument type, appropriate three-dimensional position and gain change depending on features of sounds of the object, a genre of music, and the like.

Finally, the mixing engineer listens to the sounds reproduced in a state where the object is actually arranged in the three-dimensional space, and checks auditory masking between objects, that is, whether an important sound is masked by another sound and becomes difficult to hear. In a case where an important sound is masked by another sound, the mixing engineer repeats adjustment so as to obtain an optimal sound by adjusting the position and gain of the object.

Note that the auditory masking referred to herein is frequency masking (simultaneous time masking) in which a sound of a certain frequency masks a sound of another frequency reproduced simultaneously.

The mixing work requires a high degree of experience, knowledge, and time in listening to a sound and determining the three-dimensional position and the gain of the object on the basis of listening to the sound.

Depending on the scale of content, it generally takes several hours for the mixing engineer to mix one piece of content. If the mixing work can be shortened, more 3D audio content can be produced, leading to further spread of 3D audio.

As a technique for shortening mixing in object audio, that is, determination of three-dimensional position information, gain, and the like of an object, a technique for automatically determining the position and gain of an object from an audio signal of the object has been proposed (see, for example, Patent Document 1).

### CITATION LIST

### Patent Document

Patent Document 1: WO 2020/066681 A1

### SUMMARY OF THE INVENTION

### Problems to be Solved by the Invention

However, even if the above-described technique is used, it is necessary to perform a process in which the mixing engineer confirms listening to the influence of masking between objects in the three-dimensional space and adjusts the position and gain of the object. Thus, it is desired to further shorten the production time of 3D audio content.

The present technology has been made in view of such a situation, and enables content to be produced in a shorter time.

### Solutions to Problems

An information processing apparatus according to a first aspect of the present technology includes a masking information calculation unit that calculates, as an inter-object masking frequency characteristic, an auditory masking amount at each frequency of a target object with one or more other objects on the basis of a frequency spectrum and object position information of the target object, and the frequency spectrum and the object position information of the one or more other objects different from the target object, and a display control unit that displays the frequency spectrum of the target object and the inter-object masking frequency characteristic.

An information processing method or a program according to the first aspect of the present technology includes calculating, as an inter-object masking frequency characteristic, an auditory masking amount at each frequency of a target object with one or more other objects on the basis of a frequency spectrum and object position information of the target object, and the frequency spectrum and the object position information of the one or more other objects different from the target object, and displaying the frequency spectrum of the target object and the inter-object masking frequency characteristic.

In the first aspect of the present technology, an auditory masking amount at each frequency of a target object with one or more other objects is calculated as an inter-object masking frequency characteristic on the basis of a frequency spectrum and object position information of the target object, and the frequency spectrum and the object position information of the one or more other objects different from the target object, and the frequency spectrum of the target object and the inter-object masking frequency characteristic is displayed.

An encoding apparatus according to a second aspect of the present technology includes a time-frequency transform unit that performs time-frequency transform on an audio signal of an object to generate frequency spectrum information, an auditory psychological parameter calculation unit that calculates an auditory psychological parameter on the basis of the frequency spectrum information and setting information regarding a masking threshold for the object, and a bit allocation unit that performs the bit allocation processing on the basis of the auditory psychological parameter and the frequency spectrum information to generate quantized frequency spectrum information.

In the second aspect of the present technology, time-frequency transform on an audio signal of an object is performed to generate frequency spectrum information, an auditory psychological parameter is calculated on the basis of the frequency spectrum information and setting information regarding a masking threshold for the object, and the bit allocation processing is performed on the basis of the auditory psychological parameter and the frequency spectrum information to generate quantized frequency spectrum information.

An audio reproducing apparatus according to a third aspect of the present technology includes a recording unit that records arrangement setting information indicating an arrival direction of an external sound and a direction in which a target sound is easily heard with respect to the arrival direction of the external sound, a sound pickup unit that performs sound pickup of ambient sound, a control unit that estimates the arrival direction of the external sound on the basis of a sound pickup signal obtained by the sound pickup and generates a reproduction signal in which a sound image of the target sound is localized in a direction in which the target sound indicated by the arrangement setting information corresponding to an estimation result of the arrival direction of the external sound is easily heard on the basis of the sound pickup signal, and a reproducing unit that reproduces a sound on the basis of the reproduction signal.

In the third aspect of the present technology, arrangement setting information indicating an arrival direction of an external sound and a direction in which a target sound is easily heard with respect to the arrival direction of the external sound is recorded, sound pickup of ambient sound is performed, the arrival direction of the external sound is estimated on the basis of a sound pickup signal obtained by the sound pickup and a reproduction signal in which a sound image of the target sound is localized in a direction in which the target sound indicated by the arrangement setting information corresponding to an estimation result of the arrival direction of the external sound is easily heard is generated on the basis of the sound pickup signal, and a sound is reproduced on the basis of the reproduction signal.

An information processing apparatus according to a fourth aspect of the present technology includes a control unit that displays a position adjustment screen indicating an arrangement position of an external sound in a space and an arrangement position of a target sound, moves the arrangement position of the target sound in the space according to an operation of a user, reproduces the external sound and the target sound at a sound image position according to the arrangement position, and generates arrangement setting information indicating an arrival direction of the external sound and a direction in which the target sound is easily heard and which is set by the user with respect to the arrival direction of the external sound on the basis of the arrangement position of the external sound and the arrangement position of the target sound.

In the fourth aspect of the present technology, a position adjustment screen indicating an arrangement position of an external sound in a space and an arrangement position of a target sound is displayed, the arrangement position of the target sound in the space moves according to an operation of a user, the external sound and the target sound at a sound image position according to the arrangement position are reproduced, and arrangement setting information indicating an arrival direction of the external sound and a direction in which the target sound is easily heard and which is set by the user with respect to the arrival direction of the external sound is generated on the basis of the arrangement position of the external sound and the arrangement position of the target sound.

### BRIEF DESCRIPTION OF DRAWINGS

FIG. 1 is a diagram illustrating a configuration example of an information processing apparatus.

FIG. 2 is a diagram illustrating an example of a three-dimensional equal loudness characteristic table.

FIG. 3 is a diagram illustrating an example of a frequency characteristic display screen.

FIG. 4 is a flowchart describing GUI display processing.

FIG. 5 is a diagram illustrating another configuration example of the information processing apparatus.

FIG. 6 is a diagram describing a reflective object.

FIG. 7 is a diagram illustrating a configuration example of the information processing apparatus.

FIG. 8 is a flowchart describing GUI display processing.

FIG. 9 is a diagram illustrating an example of alert display.

FIG. 10 is a diagram illustrating a configuration example of the information processing apparatus.

FIG. 11 is a flowchart describing GUI display processing.

FIG. 12 is a diagram illustrating a display example of candidates for a movement destination of an object.

FIG. 13 is a flowchart describing GUI display processing.

FIG. 14 is a diagram illustrating a configuration example of the encoder.

FIG. 15 is a flowchart illustrating encoding processing.

FIG. 16 is a diagram illustrating an adjustment example of an arrangement position of target sounds.

FIG. 17 is a diagram illustrating a configuration example of an audio reproducing device.

FIG. 18 is a diagram illustrating a configuration example of a computer.

### MODE FOR CARRYING OUT THE INVENTION

Hereinafter, embodiments to which the present technology is applied will be described with reference to the drawings.

### First Embodiment

### <Configuration Example of Information Processing Apparatus>

The present technology enables visual understanding of a masking effect between objects by displaying frequency characteristics of auditory masking between objects in a three-dimensional space as a graphical user interface (GUI) graph. Thus, the number of times of listening necessary for repeating adjustment of the object position and the gain can be reduced, and the content production time can be further shortened.

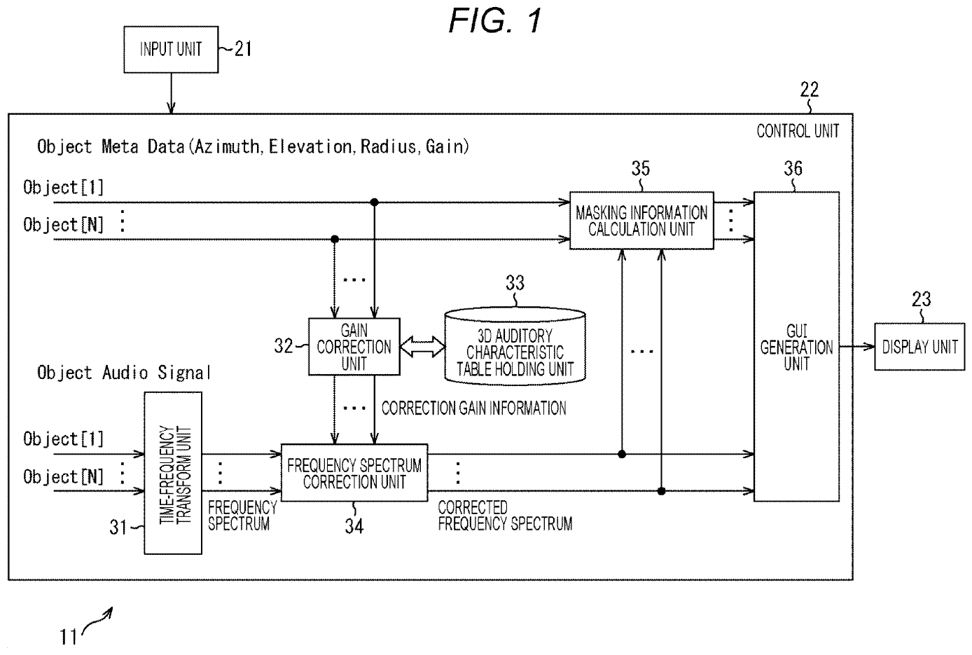

FIG. 1 is a diagram illustrating a configuration example of an embodiment of an information processing apparatus to which the present technology is applied.

An information processing apparatus 11 illustrated in FIG. 1 includes, for example, a personal computer or the like.

A user who is a mixing engineer (content producer) can produce 3D audio content by mixing software, that is, a content production tool operating in the information processing apparatus 11.

For example, the user performs mixing by adding object position information indicating a position of an object in a three-dimensional space and gain information indicating gain of a sound of the object on the mixing software to an audio signal divided for each object such as each instrument or sound effect.

The information processing apparatus 11 includes an input unit 21, a control unit 22, and a display unit 23. Note that the display unit 23 may be a device different from the information processing apparatus 11.

The input unit 21 includes, for example, a mouse, a keyboard, and the like, and supplies a signal corresponding to a user's operation to the control unit 22.

The control unit 22 controls the entire operation of the information processing apparatus 11. The control unit 22 includes a time-frequency transform unit 31, a gain correction unit 32, a 3D auditory characteristic table holding unit 33, a frequency spectrum correction unit 34, a masking information calculation unit 35, and a GUI generation unit 36.

In the control unit 22, the audio signal of each object constituting the content is supplied to the time-frequency transform unit 31, and metadata of each object constituting the content is supplied to the gain correction unit 32 and the masking information calculation unit 35.

In FIG. 1, Object [k](where k=1, 2, . . . , N) represents a k-th object constituting the content, and audio signals of N objects are input to the time-frequency transform unit 31. Furthermore, metadata of each of N objects is input to the gain correction unit 32 and the masking information calculation unit 35.

Here, the metadata of the object includes object position information and gain information designated (input) by the user operating the input unit 21 or the like.

The object position information includes, for example, a horizontal angle (Azimuth), a vertical angle (Elevation), and a distance (Radius). Note that the object position information is not limited to the above notation, and may be described in another format such as XYZ format, for example.

The horizontal angle and the vertical angle are angles in the horizontal direction and the vertical direction indicating a position of an object viewed from a listening position serving as a reference in the three-dimensional space. Furthermore, the distance (Radius) indicates a distance (radius) from the listening position serving as a reference to the object, which indicates the position of the object in the three-dimensional space.

The time-frequency transform unit 31 performs time-frequency transform using Modified Discrete Cosine Transform (MDCT) on the supplied audio signal of each object. Thus, the audio signal that is a time signal is converted into a frequency spectrum that is a signal in a frequency domain.

The time-frequency transform unit 31 supplies the frequency spectrum obtained by the time-frequency transform to the frequency spectrum correction unit 34. Note that the gain information included in the metadata may be supplied to the time-frequency transform unit 31, and the time-frequency transform unit 31 may perform gain correction on the audio signal or the frequency spectrum on the basis of the gain information.

The gain correction unit 32 obtains correction gain information on the basis of the supplied metadata of each object and the three-dimensional equal loudness characteristic table held in the 3D auditory characteristic table holding unit 33, and supplies the correction gain information to the frequency spectrum correction unit 34.

The correction gain information is information indicating a gain for performing gain correction in consideration of the three-dimensional equal loudness characteristic according to the position of each object in the three-dimensional space with respect to the frequency spectrum of each object.

It is known that subjective sound pressure sensitivity, that is, auditory sensitivity (how to feel the magnitude of sound) of a human (listener) varies depending on the arrival direction of the sound from the sound source to the listener. For example, if the sound pressure sensitivity of a certain sound is high, the sound is less likely to be masked (more likely to be masked), and thus the frequency spectrum correction unit 34 performs gain correction in consideration of characteristics regarding such a sound arrival direction and sound pressure sensitivity, that is, three-dimensional equal loudness characteristics.

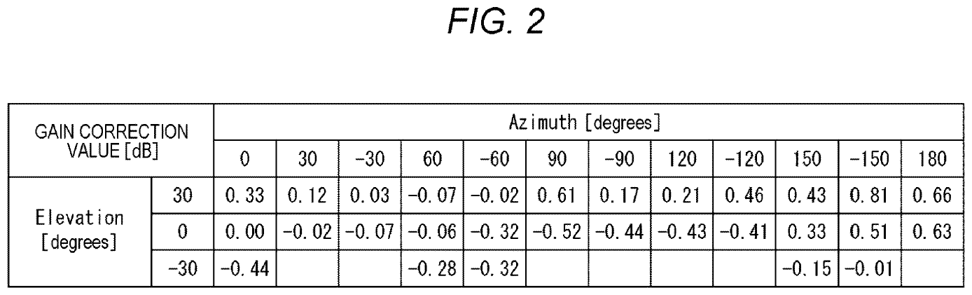

For example, the 3D auditory characteristic table holding unit 33 holds a three-dimensional equal loudness characteristic table illustrated in FIG. 2.

In this example, the three-dimensional equal loudness characteristic table stores a gain correction value (dB) corresponding to each position (object position) in the three-dimensional space defined by the horizontal angle (Azimuth) and the vertical angle (Elevation) constituting the object position information.

In other words, in the three-dimensional equal loudness characteristic table, the arrival direction of the sound from the object as a sound source to the listener, that is, the direction (position) of the sound source viewed from the listener, and the gain correction value corresponding to the direction are associated with each other. Note that, here, the value of the distance (Radius) constituting the object position information is assumed to be 1.0 m.

The gain correction value indicated by the three-dimensional equal loudness characteristic table is determined according to the auditory characteristics of the person with respect to the sound arrival direction, and is a gain correction amount that makes the magnitude of an audible sound constant regardless of the sound arrival direction in particular. In other words, the gain correction value is a correction value for correcting the gain value based on the auditory characteristic (three-dimensional equal loudness characteristic) related to the sound arrival direction.

Therefore, if the audio signal of the object is gain-corrected by the gain correction value indicated by the three-dimensional equal loudness characteristic table, the sound of the same object can be heard with the same magnitude regardless of the position of the object.

For example, in a case where the sound source is on the right side as viewed from the listener, that is, in a case where Azimuth is 90 degrees and Elevation is 0 degrees, the listener hears the sound from the sound source louder than in a case where the sound source is in front as viewed from the listener, that is, in a case where Azimuth is 0 degrees and Elevation is 0 degrees (the gain correction value is “0.00”). Thus, a gain correction value “−0.52” for performing gain correction to reduce the sound from the sound source is determined for the position where Azimuth=90 degrees and Elevation=0 degrees.

Note that the position of the object is not necessarily at the position where the corresponding gain correction value is stored in the three-dimensional equal loudness characteristic table.

Specifically, for example, it is assumed that the three-dimensional equal loudness characteristic table illustrated in FIG. 2 is held in the 3D auditory characteristic table holding unit 33, and the horizontal angle, the vertical angle, and the distance as the object position information are −120 degrees, 15 degrees, and 1.0 m.

In this case, the gain correction values corresponding to the horizontal angle “−120”, the vertical angle “15”, and the distance “1.0” are not stored in the three-dimensional equal loudness characteristic table of FIG. 2.

Accordingly, in a case where there is no gain correction value corresponding to the position indicated by the object position information in the three-dimensional equal loudness characteristic table, the gain correction unit 32 may calculate the gain correction value at a desired position by interpolation processing or the like using the gain correction values at a plurality of positions adjacent to the position indicated by the object position information and at which the corresponding gain correction value exists. In other words, the gain correction value at the position indicated by the object position information is obtained by performing interpolation processing or the like on the basis of the gain correction value associated with each of the plurality of positions in the vicinity of the position indicated by the object position information.

For example, there is a method using vector base amplitude panning (VBAP) as one of gain correction value interpolation methods.

VBAP (3-point VBAP) is an amplitude panning technique often used in the rendering of three-dimensional spatial acoustics.

In VBAP, a weighted gain is given to each of three real speakers in the vicinity of any virtual speaker to reproduce a sound source signal, so that the position of the virtual speaker can be arbitrarily changed.

At that time, a gain vg1, a gain vg2, and a gain vg3 of each real speaker are obtained so that the direction of a combined vector obtained by weighting and adding a vector L1, a vector L2, and a vector L3 in three directions from the listening position to each real speaker with the gain to be given to the real speaker coincides with a direction (Lp) of the virtual speaker. Specifically, when the direction of the virtual speaker, that is, the vector from the listening position to the virtual speaker is the vector Lp, the gains vg1 to vg3 satisfying the following Expression (1) are obtained.

$$\begin{matrix}[ Math . 1 ] & \\ Lp = L 1 * vg 1 + L 2 * vg 2 + L 3 * vg 2 & ( 1 )\end{matrix}$$

Here, the positions of the above-described three real speakers are positions where three gain correction values CG1, CG2, and CG3 corresponding to the three-dimensional equal loudness characteristic table exist. Furthermore, the position of the virtual speaker described above is set to any position where there is no gain correction value corresponding to the three-dimensional equal loudness characteristic table.

At this time, the gain correction value CGp at the position of the virtual speaker can be obtained by calculating the following Expression (2).

$$\begin{matrix}[ Math . 2 ] & \\ Ri = vgi / \sqrt{( vg 1 * vg 1 + vg 2 * vg 2 + vg 3 * vg 3 )} & ( 2 )\end{matrix}$$

$$i = 1 , 2 , 3$$

$$CGp = R 1 * CG 1 + R 2 * CG 2 + R 3 * CG 3$$

In Expression (2), first, normalization is performed so that the sum of squares becomes 1 with respect to the gain vg1, the gain vg2, and the gain vg3 of the weighting described above obtained by VBAP, and a ratio R1, a ratio R2, and a ratio R3 are obtained.

Then, a combined gain obtained by weighting and adding the gain correction value CG1, the gain correction value CG2, and the gain correction value CG3 at the real speaker position by the obtained ratios R1, R2, and R3 is set as the gain correction value CGp at the position of the virtual speaker.

Specifically, the mesh is divided at a plurality of positions where the gain correction value is prepared in the three-dimensional space. That is, for example, if gain correction values for three respective positions in a three-dimensional space are prepared, one triangular region having the three positions as vertices is one mesh.

When the three-dimensional space is divided into a plurality of meshes in this manner, a desired position for obtaining the gain correction value is set as an attention position, and a mesh including the position of interest is specified.

Furthermore, a coefficient to be multiplied by a position vector indicating each of the three vertex positions when the position vector indicating the position of interest is represented by multiplication and addition of position vectors indicating the three vertex positions constituting the identified mesh is obtained by VBAP.

Then, each of the three coefficients thus obtained normalized so that the sum of squares becomes 1 is multiplied by each of the gain correction values of the three vertex positions of the mesh including the position of interest, and the sum of the gain correction values multiplied by the coefficients is calculated as the gain correction value of the position of interest. Furthermore, the normalization may be performed by any method such as making the sum or the sum equal to or greater than the third power be 1.

Note that the method of interpolating the gain correction value is not limited to the interpolation using VBAP, and any other method may be used.

For example, an average value of the gain correction values at a plurality of positions such as N (for example, N=5) positions in the vicinity of the position of interest among the positions where the gain correction value exists in the three-dimensional equal loudness characteristic table may be used as the gain correction value of the position of interest.

Furthermore, for example, the gain correction value at the position closest to the position of interest and at which the gain correction value is prepared (stored) among the positions where the gain correction value exists in the three-dimensional equal loudness characteristic table may be used as the gain correction value of the target position.

Returning to the description of FIG. 1, the gain correction unit 32 reads the gain correction value associated with the position indicated by the object position information included in the metadata from the three-dimensional equal loudness characteristic table, and supplies the read gain correction value to the frequency spectrum correction unit 34 as the correction gain information.

Note that the gain correction based on the gain information included in the metadata may be performed in the time-frequency transform unit 31 or may be performed in the frequency spectrum correction unit 34.

For example, in a case where the gain correction based on the gain information is performed in the frequency spectrum correction unit 34, the gain correction unit 32 generates the correction gain information on the basis of the gain information and the gain correction value determined by the object position information read from the three-dimensional equal loudness characteristic table.

In this case, by performing the gain correction based on the correction gain information, the gain correction based on the gain information designated by the user and the gain correction based on the gain correction value in consideration of the three-dimensional equal loudness characteristic are simultaneously performed. In other words, the gain indicated by the gain information is corrected by the gain correction value. Hereinafter, it is assumed that the gain correction based on the gain information is performed in the frequency spectrum correction unit 34.

The frequency spectrum correction unit 34 performs gain correction on the frequency spectrum supplied from the time-frequency transform unit 31 on the basis of the correction gain information supplied from the gain correction unit 32, and supplies a corrected frequency spectrum obtained as a result to the masking information calculation unit 35 and the GUI generation unit 36.

The corrected frequency spectrum of the object obtained by the frequency spectrum correction unit 34 is information indicating the frequency characteristics of the sound of the object constituting the content. In particular, here, the corrected frequency spectrum is a frequency characteristic in consideration of the three-dimensional equal loudness characteristic.

On the basis of the corrected frequency spectrum of each object supplied from the frequency spectrum correction unit 34, the masking information calculation unit 35 calculates, for each object, an auditory masking amount at each frequency in the object, that is, a masking threshold (frequency masking threshold) as an intra-object masking threshold. The masking threshold is a threshold of a boundary of a sound pressure at which sound cannot be heard due to masking, and sound smaller than the threshold is not audibly perceived.

The intra-object masking threshold is information indicating masking frequency characteristics related to sound of one object, that is, characteristics of masking between frequency components. Hereinafter, the masking frequency characteristic indicated by the intra-object masking threshold at each frequency is also referred to as an intra-object masking frequency characteristic.

For example, a sound of one object includes a plurality of frequency components, and a sound of each frequency component masks a sound of another frequency component. In other words, even in a case where there is no sound source other than one object in the three-dimensional space, the sound of a high frequency component of the object masks the sound of another low frequency in the vicinity of the frequency component.

Note that a method of calculating the intra-object masking threshold, and the like are described in detail in, for example, “Marina Bosi and Richard E. Goldberg “Introduction to Digital Audio Coding and Standards” Kluwer Academic Publishers, 2002.”

Furthermore, in the following description, frequency masking is simply referred to as masking, but successive masking may be used instead of frequency masking, or both frequency masking and successive masking may be used. That is, the characteristic related to the masking threshold in consideration of at least one of the frequency masking or the successive masking can be graphically displayed on the display unit 23.

The frequency masking is a phenomenon in which sound of a certain frequency masks sound of another frequency and makes it difficult to be heard when sounds of a plurality of frequencies are reproduced at the same time.

The successive masking is a phenomenon in which, when a certain sound is reproduced, sounds reproduced before and after in terms of time are masked to make it difficult to be heard.

Furthermore, the masking information calculation unit 35 calculates an inter-object masking threshold for each combination of two objects on the basis of the corrected frequency spectrum of each object and the object position information included in the metadata of each object supplied from the input unit 21.

The inter-object masking threshold is an auditory masking amount at each frequency between objects, that is, a masking threshold (spatial masking threshold).

In other words, the inter-object masking threshold is information indicating masking frequency characteristics related to sound between objects. Hereinafter, the masking frequency characteristic indicated by the inter-object masking threshold at each frequency is also referred to as an inter-object masking frequency characteristic.

For example, the inter-object masking threshold can be obtained by using a table obtained by a subjective evaluation experiment.

Note that the inter-object masking threshold is not limited to a method using a table obtained by a subjective evaluation experiment, and may be obtained by any other method.

For example, a spatial masking model may be constructed using the result of the subjective evaluation experiment, and the inter-object masking threshold may be obtained on the basis of the spatial masking model.

Moreover, the masking information calculation unit 35 calculates, for each object, a combined value of the inter-object masking threshold with another object for each frequency, and sets the obtained combined value as a masking combined value (spatial masking threshold).

The combined value of the inter-object masking thresholds may be, for example, an addition value (total value) of a plurality of inter-object masking thresholds, or may be a value obtained by weighted addition of a plurality of inter-object masking thresholds with a predetermined weight.

At this time, the weight used for the weighted addition may be determined on the basis of a positional relationship, a distance, or the like between the listening position serving as a reference in the three-dimensional space and the object, or may be determined in advance for the type or the like of the object. Furthermore, a weight may be determined for each frequency, and in particular, a common weight may be used for all objects determined for each frequency. Furthermore, the weight may be determined on the basis of an element other than those described above.

The masking combined value is the auditory masking amount for each frequency, that is, the masking threshold (spatial masking threshold), related to sound from all other objects in the three-dimensional space of the object. Note that the auditory masking amount for each frequency related to the sound from not all the other objects but some (two or more) other objects in the three-dimensional space of the object may be obtained as the masking combined value. Furthermore, the masking combined value may be a combined value of the inter-object masking threshold with a plurality of other objects and the intra-object masking threshold for each frequency. Hereinafter, the masking frequency characteristic indicated by the masking combined value at each frequency is also referred to as a combined masking frequency characteristic.

The masking information calculation unit 35 obtains the intra-object masking threshold (intra-object masking frequency characteristic), the inter-object masking threshold (inter-object masking frequency characteristic), and the masking combined value (combined masking frequency characteristic) for at least one object, and supplies the obtained values to the GUI generation unit 36.

The GUI generation unit 36 generates image data for displaying a frequency characteristic display screen on the basis of the corrected frequency spectrum supplied from the frequency spectrum correction unit 34 and the intra-object masking threshold, the inter-object masking threshold, and the masking combined value supplied from the masking information calculation unit 35, and supplies the image data to the display unit 23. The GUI generation unit 36 functions as a display control unit that causes the display unit 23 to display the frequency characteristic display screen or the like on the basis of the image data.

In the frequency characteristic display screen, for at least one object, the frequency characteristic, the intra-object masking frequency characteristic, the inter-object masking frequency characteristic, and the combined masking frequency characteristic in consideration of the three-dimensional equal loudness characteristic of the object are graphically displayed.

That is, by supplying the image data to the display unit 23, the GUI generation unit 36 causes the display unit 23 to display the frequency characteristic, the intra-object masking frequency characteristic, the inter-object masking frequency characteristic, and the combined masking frequency characteristic in consideration of the three-dimensional equal loudness characteristic of the object as a graph of the GUI.

Note that the user can specify for which object the intra-object masking frequency characteristic or the like is to be displayed by operating the input unit 21.

Hereinafter, in order to simplify the description, it is assumed that the intra-object masking frequency characteristic and the like are displayed for one object on the frequency characteristic display screen.

Furthermore, hereinafter, an object for which the intra-object masking frequency characteristic and the like are displayed on the frequency characteristic display screen is also particularly referred to as a target object. Moreover, regarding the target object, another object different from the target object when the inter-object masking frequency characteristic is displayed is also referred to as a designated other object. The target object and the designated other object can be designated by the user.

In addition, the user may be allowed to designate (select) which one of the frequency characteristic, the intra-object masking frequency characteristic, the inter-object masking frequency characteristic, and the combined masking frequency characteristic of the object is to be graphically displayed on the frequency characteristic display screen. At this time, any one or more of the frequency characteristic, the intra-object masking frequency characteristic, and the like of the object may be specified.

The display unit 23 includes, for example, a display, and displays various images (screens) such as a frequency characteristics display screen on the basis of the image data supplied from the GUI generation unit 36.

In the information processing apparatus 11 as described above, when the user changes the designated other object, adds an object, or changes the object position information or the gain information of the object, the frequency characteristic display screen is updated according to the change or addition.

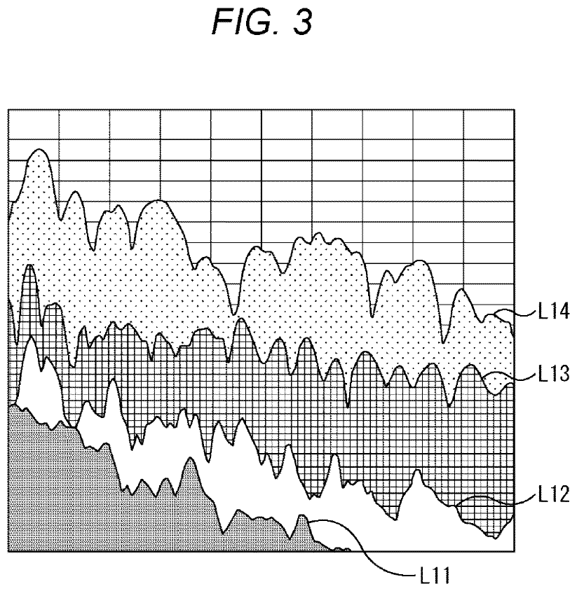

The display unit 23 displays, for example, the frequency characteristic display screen illustrated in FIG. 3.

In FIG. 3, the horizontal axis represents frequency, and the vertical axis represents amplitude (level). A curve L11 indicates the intra-object masking frequency characteristic (intra-object masking threshold) of the target object, and a curve L12 indicates the inter-object masking frequency characteristic (inter-object masking threshold) between the target object and the designated other object.

A curve L13 indicates the combined masking frequency characteristic (masking combined value) for the target object, and a curve L14 indicates the frequency characteristic (corrected frequency spectrum) of the target object in consideration of the three-dimensional equal loudness characteristic.

For example, focusing on the relationship between the target object and all the objects other than the target object arranged in the three-dimensional space, when the corrected frequency spectrum indicated by the curve L14 becomes smaller than the masking combined value indicated by the curve L13, the sound of the target object is masked by the sound of the other object and cannot be heard.

Furthermore, focusing on the target object and the designated other object, when the corrected frequency spectrum indicated by the curve L14 becomes smaller than the inter-object masking threshold indicated by the curve L12, the sound of the target object is masked by the sound of the designated other object and becomes unhearable.

The user operates the input unit 21 to designate (adjust) the object position information and the gain information of each object while confirming the frequency characteristics indicated by the curves L11 to L14.

On the frequency characteristic display screen, the frequency characteristic of the target object indicated by the curve L14, the inter-object masking frequency characteristic indicated by the curve L12, and the combined masking frequency characteristic indicated by the curve L13 are graphically displayed.

Even if only the frequency characteristics of each of the plurality of objects are graphically displayed, it is difficult for the user to understand the effect of the auditory masking between the objects.

On the other hand, in the frequency characteristic display screen illustrated in FIG. 3, not only the frequency characteristic of the target object but also the inter-object masking frequency characteristic and the combined masking frequency characteristic are graphically displayed. Thus, the user can visually understand the effect of the auditory masking between the objects according to the object position information and the gain information of each object.

Thus, it is possible to reduce the number of times of trial listening confirmation required in the process of repeating the adjustment of the object position information and the gain information, and it is possible to produce the 3D audio content in a shorter time.

Note that not only the frequency characteristic (corrected frequency spectrum) of the target object but also the frequency characteristic (corrected frequency spectrum) of another object such as the designated other object may be displayed on the frequency characteristic display screen.

Furthermore, the user may be allowed to specify (select) an object to be used for calculation of the masking combined value (combined masking frequency characteristic). In such a case, for example, one or more objects around the target object in the three-dimensional space are selected by the user, and a combined value of the inter-object masking thresholds of the selected objects is obtained as the masking combined value.

### <Description of GUI Display Processing>

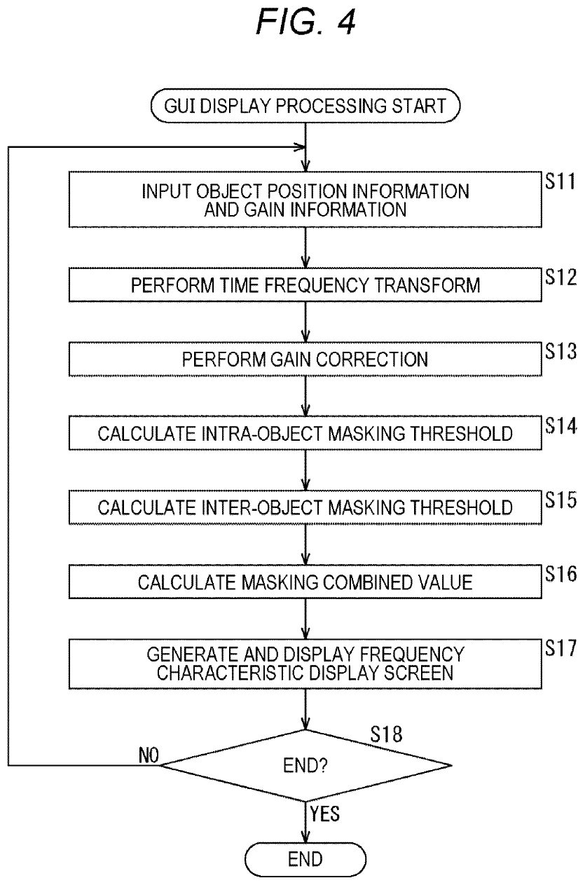

Next, the operation of the information processing apparatus 11 will be described. That is, GUI display processing performed by the information processing apparatus 11 will be described below with reference to a flowchart of FIG. 4.

In step S11, the input unit 21 inputs the object position information and the gain information according to the user's designation operation.

That is, the input unit 21 supplies a signal indicating the object position information and the gain information of the object designated by the designation operation by the user to the control unit 22. At this time, the user operates the input unit 21 as necessary to designate the target object and the designated other object, and the input unit 21 also supplies a signal corresponding to the designation to the control unit 22.

In step S12, the time-frequency transform unit 31 performs time-frequency transform on the supplied audio signal of each object, and supplies a frequency spectrum obtained as a result to the frequency spectrum correction unit 34.

In step S13, the frequency spectrum correction unit 34 performs gain correction on the frequency spectrum supplied from the time-frequency transform unit 31, and supplies the corrected frequency spectrum obtained as a result to the masking information calculation unit 35 and the GUI generation unit 36.

For example, the gain correction unit 32 reads the gain correction value associated with the position indicated by the object position information from the three-dimensional equal loudness characteristic table held in the 3D auditory characteristic table holding unit 33 on the basis of the object position information included in the supplied metadata of each object.

Then, the gain correction unit 32 calculates the correction gain information by correcting the gain information included in the metadata of the object on the basis of the read gain correction value, and supplies the correction gain information to the frequency spectrum correction unit 34.

The frequency spectrum correction unit 34 generates the corrected frequency spectrum by performing gain correction on the frequency spectrum supplied from the time-frequency transform unit 31 on the basis of the correction gain information supplied from the gain correction unit 32.

In step S14, the masking information calculation unit 35 calculates the intra-object masking threshold for the target object indicated by the signal supplied from the input unit 21 on the basis of the corrected frequency spectrum of the target object supplied from the frequency spectrum correction unit 34.

In step S15, the masking information calculation unit 35 calculates the inter-object masking threshold between the target object and another object on the basis of the corrected frequency spectrum of each object and the object position information of each object supplied from the input unit 21.

In step S16, the masking information calculation unit 35 calculates the masking combined value for the target object by obtaining the combined value of the inter-object masking threshold obtained for each object in step S15 for each frequency.

The masking information calculation unit 35 supplies the intra-object masking threshold, the inter-object masking threshold, and the masking combined value obtained in the above processing of steps S14 to S16 to the GUI generation unit 36.

In step S17, the GUI generation unit 36 generates image data of the frequency characteristic display screen according to the target object and the designated other object indicated by the signal supplied from the input unit 21, and supplies the generated image data to the display unit 23 to display the frequency characteristic display screen.

That is, the GUI generation unit 36 generates the image data of the frequency characteristic display screen on the basis of the corrected frequency spectrum supplied from the frequency spectrum correction unit 34 and the intra-object masking threshold, the inter-object masking threshold, and the masking combined value supplied from the masking information calculation unit 35.

Thus, for example, the image data of the frequency characteristic display screen illustrated in FIG. 3 is generated. The frequency characteristic display screen graphically displays the frequency characteristic of the target object in consideration of the intra-object masking frequency characteristic of the target object, the inter-object masking frequency characteristic between the target object and the designated other object, the combined masking frequency characteristic for the target object, and the three-dimensional equal loudness characteristic.

In step S18, the control unit 22 determines whether or not to end the mixing, that is, the processing of adjusting the object position information and the gain information.

In a case where it is determined not to end the processing yet in step S18, thereafter, the processing returns to step S11, and the above-described processing is repeatedly performed.

In this case, for example, in step S11, the target object or the designated other object is changed, or the object position information or the gain information of any object is changed (adjusted). Furthermore, in step S11, a new object may be added, and object position information and gain information of the object may be input.

Thus, in subsequent steps S13 to S16, the corrected frequency spectrum, the intra-object masking frequency characteristic, the inter-object masking frequency characteristic, and the combined masking frequency characteristic reflecting these changes and additions are obtained.

Then, in step S17, the display of the frequency characteristic display screen is updated according to the target object, the designated other object, the object position information, the change of the gain information, the addition of a new object, and the like. That is, the corrected frequency spectrum reflecting the change or addition, the intra-object masking frequency characteristic, the inter-object masking frequency characteristic, and the combined masking frequency characteristic are displayed.

Note that in a case where the processing of steps S11 to S17 is repeatedly performed, the processing of step S12 may be performed only once.

Furthermore, in a case where it is determined in step S18 to end the processing, the control unit 22 generates metadata of each object including the object position information and the gain information designated for each object and records the metadata in the recording unit, which is not illustrated, and the GUI display processing is ended.

As described above, the information processing apparatus 11 generates the image data of the frequency characteristic display screen on which the inter-object masking frequency characteristic and the combined masking frequency characteristic are graphically displayed, and displays the frequency characteristic display screen.

In this way, the user can visually understand the effect of the auditory masking between the objects. As a result, the number of times of listening confirmation required in the process of repeating the adjustment of the object position information and the gain information can be reduced, and the 3D audio content can be produced in a shorter time.

### <Modification 1 of First Embodiment>

### <Another Configuration Example of Information Processing Apparatus>

Note that, in the information processing apparatus 11 illustrated in FIG. 1, an example has been described in which the three-dimensional equal loudness characteristic according to the position of each object in the three-dimensional space is considered. However, the three-dimensional equal loudness characteristic need not be particularly considered.

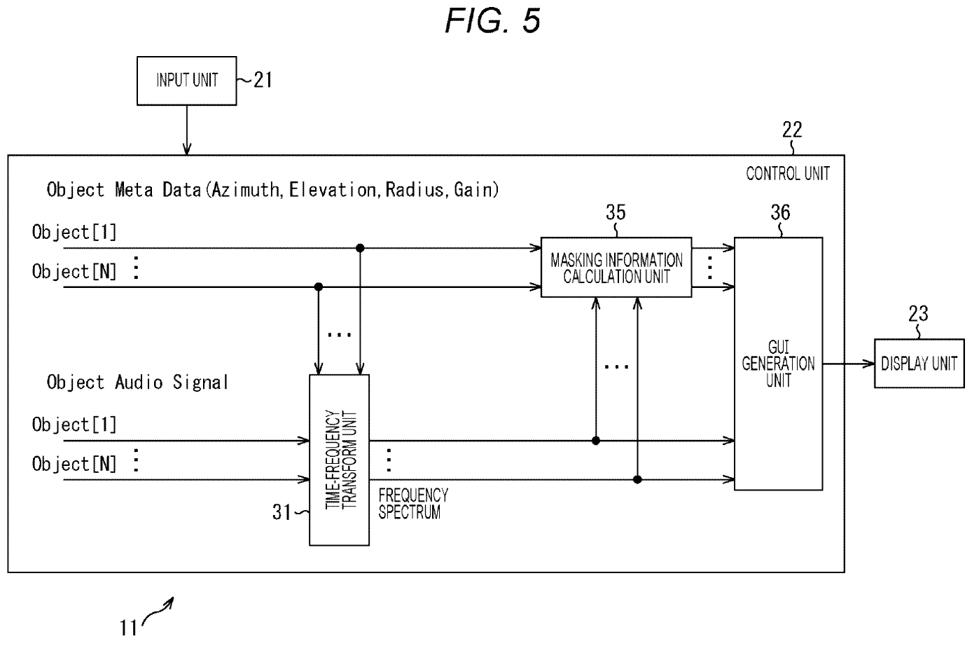

In such a case, the information processing apparatus 11 is configured as illustrated in FIG. 5, for example. Note that, in FIG. 5, portions corresponding to those in FIG. 1 are denoted by the same reference signs, and the description thereof will be omitted as appropriate.

The information processing apparatus 11 illustrated in FIG. 5 includes the input unit 21, the control unit 22, and the display unit 23. Furthermore, the control unit 22 includes the time-frequency transform unit 31, the masking information calculation unit 35, and the GUI generation unit 36.

The configuration of the information processing apparatus 11 illustrated in FIG. 5 is different from that of the information processing apparatus 11 in FIG. 1 in that the gain correction unit 32, the 3D auditory characteristic table holding unit 33, and the frequency spectrum correction unit 34 are not provided in the control unit 22, and is the same as that of the information processing apparatus 11 in FIG. 1 in other points.

The time-frequency transform unit 31 performs time-frequency transform on the supplied audio signal of each object, and supplies a frequency spectrum obtained as a result to the masking information calculation unit 35 and the GUI generation unit 36. At this time, the time-frequency transform unit 31 performs gain correction on the audio signal or the frequency spectrum on the basis of the gain information included in the supplied metadata. Therefore, the frequency spectrum subjected to the gain correction based on the gain information is supplied to the masking information calculation unit 35 and the GUI generation unit 36.

The masking information calculation unit 35 obtains the intra-object masking threshold, the inter-object masking threshold, and the masking combined value on the basis of the frequency spectrum of each object supplied from the time-frequency transform unit 31 and supplied object position information of each object, and supplies the obtained values to the GUI generation unit 36.

The GUI generation unit 36 generates image data for displaying the frequency characteristic display screen on the basis of the frequency spectrum supplied from the time-frequency transform unit 31 and the intra-object masking threshold, the inter-object masking threshold, and the masking combined value supplied from the masking information calculation unit 35, and supplies the image data to the display unit 23.

In this case, the frequency spectrum in which the three-dimensional equal loudness characteristic is not considered, that is, the frequency spectrum obtained by the time-frequency transform unit 31 is displayed on the frequency characteristic display screen as the frequency characteristic of the target object.

### Second Embodiment

### <Calculation of Frequency Characteristics Based on Acoustic Parameters>

Incidentally, an effect of auditory masking (spatial masking) is affected by reflection or reverberation of a room or the like forming a virtual three-dimensional space in which an object is arranged.

For example, if a reflected sound of a sound that masks is regarded as a virtual reflective object, a spatial masking threshold from a certain object can be considered as a total of masking by a direct sound of the object and masking from the virtual reflective object.

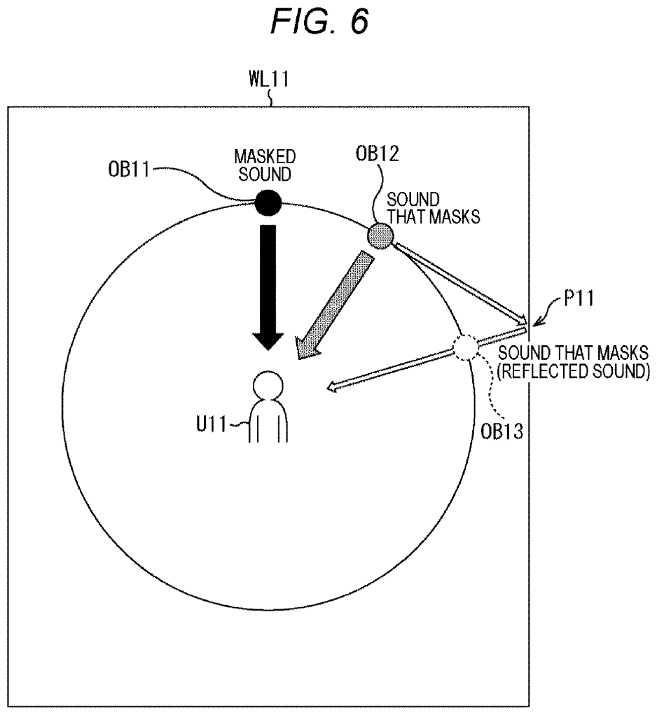

Specifically, for example, as illustrated in FIG. 6, it is assumed that a listener U11, an object OB11, and an object OB12 are arranged in a room (space) surrounded by a wall WL11. In particular, it is assumed that the object OB11 and the object OB12 are arranged on a circle centered on the listener U11.

Furthermore, it is assumed that the object OB11 in front of the listener U11 is a target object, and the object OB12 is a designated other object. That is, it is assumed that a sound from the object OB12 is a sound to be masked, and a sound from the object OB12 is a sound that masks a sound from the object OB11.

In this example, the listener U11 listens to, as the sound emitted from the object OB12, a direct sound that directly reaches the listener U11 from the object OB12, and a reflected sound that is emitted from the object OB12, is reflected at a position P11 on the wall WL11, and reaches the listener U11.

Therefore, the inter-object masking threshold between the object OB11 that is the target object and the object OB12 is a total value of the inter-object masking threshold between the object OB11 and the direct sound of the object OB12 and the inter-object masking threshold between the object OB11 and the reflected sound of the object OB12.

In order to obtain such an inter-object masking threshold of the object OB11, the reflective object OB13 is only required to be arranged at a position of an intersection between a circle in which the object OB11 and the object OB12 are arranged and a path of the reflected sound from the object OB12.

The reflective object OB13 is a virtual object corresponding to the reflected sound from the object OB12. The position of the reflective object OB13 can be obtained by a mirror image method or the like from, for example, the object position information of the object OB12 and the position of the wall WL11.

In such a case, the total value of the inter-object masking threshold between the object OB11 and the object OB12 (direct sound) and the inter-object masking threshold between the object OB11 and the reflective object OB13 (reflected sound) is obtained as the final inter-object masking threshold between the object OB11 and the object OB12.

Note that the inter-object masking threshold of the direct sound and the inter-object masking threshold of the reflected sound may be combined by weighted addition or the like, and a combined value obtained as a result may be used as the final inter-object masking threshold. Here, since the reflected sound can be largely divided into an initial reflected sound and a rear reverberation sound, different weightings may be performed for the initial reflected sound and the rear reverberation sound in the combining processing. Furthermore, the time (pre-delay) from when the direct sound is heard to when the reverberation sound starts to sound may be considered. Moreover, directivity for each object may be considered.

By considering not only the direct sound but also the reflected sound, it is possible to obtain the inter-object masking threshold in consideration of the acoustic characteristic of the three-dimensional space in which the object is arranged.

That is, it is possible to cause the display unit 23 to graphically display the inter-object masking threshold and the masking combined value when listening to the sound of the object in a room or the like as a three-dimensional space in which the object is arranged.

Note that the position (object position information), the gain (gain information), and the frequency characteristic (frequency spectrum) of the reflected sound (reflective object) can be obtained by acoustic simulation using the audio signal and the object position information of the direct sound and the acoustic parameters.

Here, the acoustic parameter is, for example, a parameter related to acoustic characteristics of a three-dimensional space in which an object is arranged, such as a size (size) of a room or the like as the three-dimensional space in which the object is arranged, reflectance of a wall, and an arrangement position (shape of the room) of the wall.

Furthermore, as the acoustic simulation, for example, a geometric acoustic simulation such as a mirror image method can be performed. In this way, it is possible to display the spatial masking threshold close to when the sound of the object is heard in the target room.

As a method of setting the acoustic parameter used for the acoustic simulation, for example, a user may select any one of the following three setting methods ST1 to ST3.
Setting method ST1: selected by a user from the amount of sound parameters prepared as presets
Setting method ST2: user inputs acoustic parameters
Setting method ST3: calculate an acoustic parameter from actual measurement data selected by a user

For example, in the setting method ST1, acoustic parameters for a plurality of spaces such as a plurality of rooms having different acoustic characteristics are prepared in advance as presets. Then, the user selects one desired acoustic parameter from the plurality of preset acoustic parameters. As an example of the setting method ST1, the user may be allowed to select a preset (acoustic parameter) set in the past by a well-known mixing engineer. In this way, it is possible to reduce barriers when a beginner or a creator with little mixing experience creates content.

In the setting method ST2, the user operates the input unit 21 to directly input parameters regarding acoustic characteristics of the space such as the size of the room (space) and the reflectance of the wall as acoustic parameters. Then, the acoustic simulation is performed using the acoustic parameters input by the user.

In the setting method ST3, in a space such as a real (actual) room corresponding to a three-dimensional space in which an object is arranged, measurement regarding acoustic characteristics such as an impulse response is performed in advance by a microphone or the like, and a measurement result is prepared as a file of actual measurement data.

Then, when the user selects a desired piece of actual measurement data from the file of the actual measurement data prepared for each of the plurality of spaces having different acoustic characteristics from each other, the acoustic parameter is calculated on the basis of the selected actual measurement data, and the acoustic simulation is performed using the acoustic parameter. As an example of the setting method ST3, actual measurement data of a studio used by a famous artist is stored, and by selecting the actual measurement data, a mixing environment similar to that of the artist can be reproduced.

### <Configuration Example of Information Processing Apparatus>

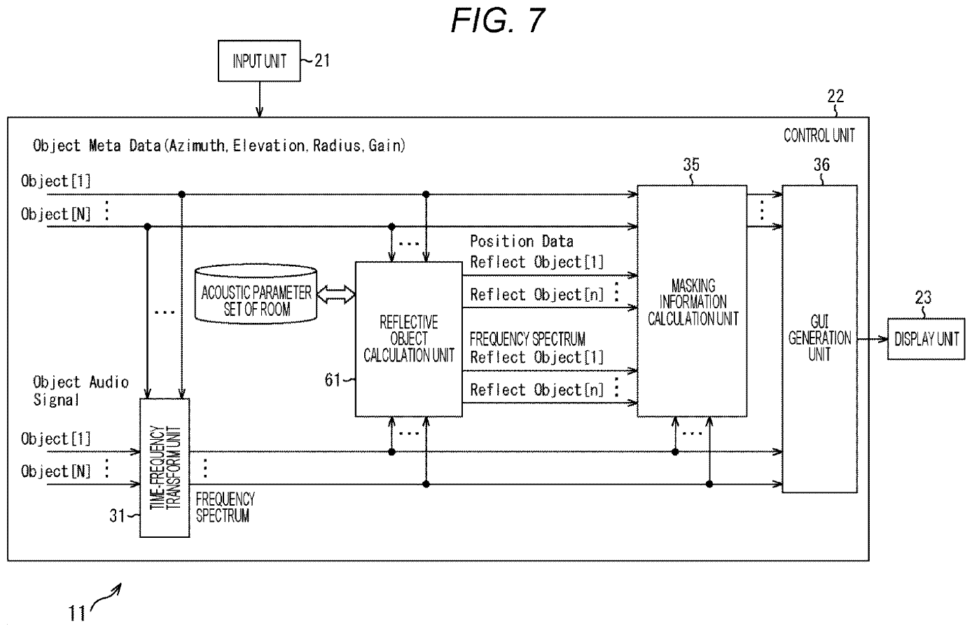

In a case where the frequency characteristic display screen is displayed in consideration of reflection of sound in space, the information processing apparatus 11 is configured as illustrated in FIG. 7, for example. Note that, in FIG. 7, portions corresponding to those in the case of FIG. 5 are denoted by the same reference signs, and the description thereof will be omitted as appropriate.

The information processing apparatus 11 illustrated in FIG. 7 includes the input unit 21, the control unit 22, and the display unit 23. Furthermore, the control unit 22 includes the time-frequency transform unit 31, a reflective object calculation unit 61, the masking information calculation unit 35, and the GUI generation unit 36.

The configuration of the information processing apparatus 11 illustrated in FIG. 7 is a configuration in which the reflective object calculation unit 61 is newly provided in the information processing apparatus 11 illustrated in FIG. 5.

The reflective object calculation unit 61 sets the acoustic parameters on the basis of the signal supplied from the input unit 21.

Furthermore, the reflective object calculation unit 61 performs acoustic simulation on the basis of the supplied metadata of each object, the frequency spectrum of each object supplied from the time-frequency transform unit 31, and the acoustic parameter.

The reflective object calculation unit 61 supplies the masking information calculation unit 35 with the object position information and the frequency spectrum of the reflective object obtained by the acoustic simulation.

The masking information calculation unit 35 obtains the intra-object masking threshold, the inter-object masking threshold, and the masking combined value on the basis of the frequency spectrum of each object supplied from the time-frequency transform unit 31, the supplied object position information of each object, and the object position information and the frequency spectrum of the reflective object supplied from the reflective object calculation unit 61, and supplies the obtained values to the GUI generation unit 36.

Note that the information processing apparatus 11 illustrated in FIG. 7 may also perform gain correction based on the three-dimensional equal loudness characteristic table.

### <Description of GUI Display Processing>

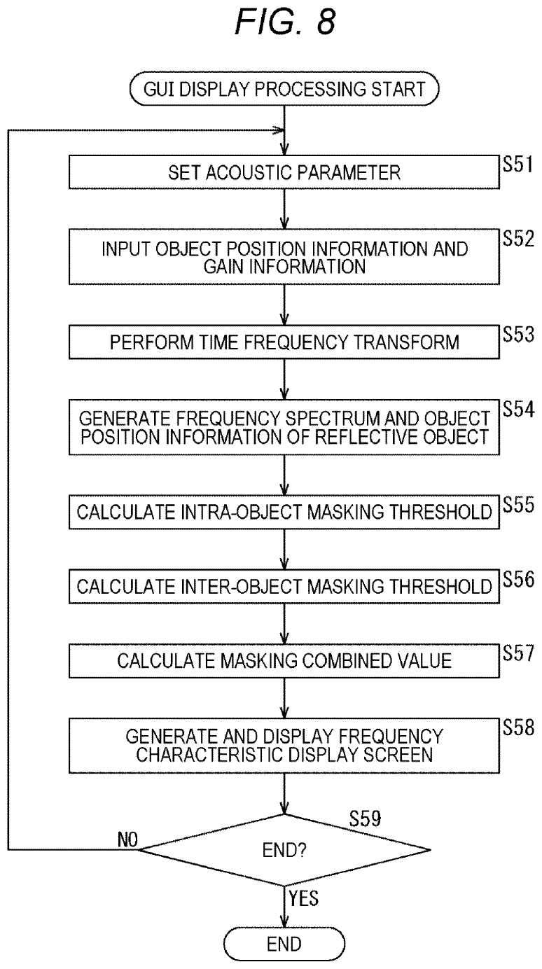

Next, GUI display processing performed by the information processing apparatus 11 having the configuration illustrated in FIG. 7 will be described. That is, the GUI display processing performed by the information processing apparatus 11 in a case where reflection of sound in a space is considered will be described below with reference to a flowchart of FIG. 8.

In step S51, the reflective object calculation unit 61 sets the acoustic parameters on the basis of the signal corresponding to the operation of the user supplied from the input unit 21.

For example, in a case where the user selects the above-described setting method ST1 and selects one acoustic parameter from among a plurality of preset acoustic parameters, the reflective object calculation unit 61 sets the acoustic parameter selected by the user to be used for the acoustic simulation.

Furthermore, for example, in a case where the user selects the above-described setting method ST2 and the acoustic parameter is input by the user, the reflective object calculation unit 61 sets the acoustic parameter input by the user to be used for the acoustic simulation.

Moreover, for example, in a case where the user selects the above-described setting method ST3 and selects one actual measurement data from among a plurality of actual measurement data prepared in advance, the reflective object calculation unit 61 calculates the acoustic parameter on the basis of the actual measurement data selected by the user. Then, the reflective object calculation unit 61 sets the calculated acoustic parameters to be used for the acoustic simulation.

After the acoustic parameters are set, processing of steps S52 and S53 is performed to generate a frequency spectrum for the direct sound of each object. Note that the processing is similar to the processing of step S11 and step S12 in FIG. 4, and thus the description thereof will be omitted.

However, in step S53, the time-frequency transform unit 31 appropriately performs gain correction on the audio signal or the frequency spectrum on the basis of the gain information included in the supplied metadata before or after the time-frequency transform.

The time-frequency transform unit 31 supplies the frequency spectrum of the direct sound of each object obtained by the time-frequency transform and the gain correction to the reflective object calculation unit 61, the masking information calculation unit 35, and the GUI generation unit 36.

In step S54, the reflective object calculation unit 61 generates the frequency spectrum and the object position information of the reflective object (reflected sound) on the basis of the supplied metadata of each object, the frequency spectrum of each object supplied from the time-frequency transform unit 31, and the acoustic parameter.

The reflective object calculation unit 61 obtains the object position information and the frequency spectrum of the reflective object by performing acoustic simulation on the basis of the metadata of the direct sound of the object, that is, the object position information and the gain information, the frequency spectrum of the direct sound of the object, and the acoustic parameter set in step S51.

For example, as described with reference to FIG. 6, the object position information of the reflective object is determined by the object position information of the object serving as the sound source of the reflected sound and the shape and size of the three-dimensional space, that is, the arrangement position and direction of the wall.

Note that the gain information of the reflective object may be obtained by acoustic simulation, and the frequency spectrum of the reflective object may be obtained from the gain information and the frequency spectrum or the audio signal of the direct sound.

In this case, the gain information of the reflective object is determined by the gain information and the object position information of the object serving as the sound source of the reflected sound, the object position information of the reflective object, the shape and size of the three-dimensional space, the reflectance of the wall of the room forming the three-dimensional space, the directivity of each object, and the like.

Furthermore, a plurality of reflective objects may be generated for one object according to the shape of a room as a three-dimensional space or the like.

After the frequency spectrum and the object position information of the reflective object are generated, processing of steps S55 to S59 is performed and the GUI display processing ends, but since the processing is similar to the processing of steps S14 to S18 of FIG. 4, the description thereof will be omitted.

However, in step S55, the masking information calculation unit 35 calculates the intra-object masking threshold on the basis of the frequency spectrum of the direct sound of each object supplied from the time-frequency transform unit 31.

Furthermore, in step S56, the masking information calculation unit 35 calculates an inter-object masking threshold on the basis of the frequency spectrum supplied from the time-frequency transform unit 31, the supplied metadata of each object, and the frequency spectrum and the object position information of the reflective object supplied from the reflective object calculation unit 61.

At this time, processing similar to that in the case of step S15 in FIG. 4 is performed, the inter-object masking threshold is calculated for the direct sound and the reflected sound, and a total value of the inter-object masking thresholds is set as a final inter-object masking threshold.

That is, the inter-object masking threshold between the target object and the designated other object that is the direct sound is calculated. Furthermore, an inter-object masking threshold between the target object and the reflective object corresponding to the designated other object, which is the reflected sound, is also calculated. Then, a total value of the inter-object masking threshold with each of the designated other objects and the inter-object masking threshold with each of the one or more reflective objects is obtained, and the obtained total value is set as a final inter-object masking threshold with each of the designated other objects of the target object.

Therefore, it can be said that the masking information calculation unit 35 calculates (computes) the inter-object masking threshold based on the acoustic parameter indicating the acoustic characteristic of the three-dimensional space in which the target object and other objects are arranged. In other words, the masking information calculation unit 35 calculates the inter-object masking threshold on the basis of the acoustic parameter.

As a result, in step S58, the inter-object masking frequency characteristic and the combined masking frequency characteristic in which the reflected sound is also considered, that is, the acoustic characteristic of the room or the like as the three-dimensional space is also considered are displayed on the frequency characteristic display screen.

As described above, the information processing apparatus 11 also generates the frequency spectrum for the reflective object, and displays the frequency characteristic display screen on which the inter-object masking frequency characteristic and the like in consideration of the acoustic characteristic of the room or the like as the three-dimensional space are graphically displayed.

In this way, it is possible to cause the user to visually understand a more accurate effect of auditory masking between objects in consideration of acoustic characteristics of a room or the like. As a result, the number of times of listening confirmation required in the process of repeating the adjustment of the object position information and the gain information can be reduced, and the 3D audio content can be produced in a shorter time.

### Third Embodiment

### <Setting of Upper Limit Value>

Incidentally, objects constituting content include an important object that is not desired to be masked from other objects. Furthermore, even in a single object, a plurality of frequency components included in an audio signal of the object includes an important frequency component that is not desired to be masked from the other objects.

Accordingly, an upper limit value of an allowable masking combined value may be set for an object or frequency that is not desired to be masked from another object.

Note that the upper limit value may be set to be common to all frequencies for one object, or may be set for each frequency for one object. Furthermore, a common upper limit value for all frequencies or an upper limit value for each frequency may be set for a plurality of objects selected by the user.

In a case where the upper limit value is set, when the masking combined value for the target object exceeds the upper limit value that is the set allowable amount, alert display indicating that the masking combined value exceeds the upper limit value is performed on the GUI. In this way, when the user moves the position of the object in the three-dimensional space, or the like, the influence of the auditory masking (spatial masking) can be visually easily understood and presented.

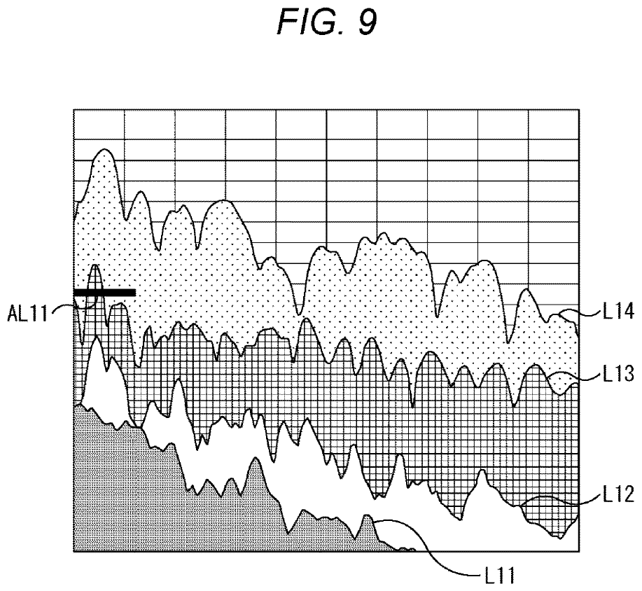

FIG. 9 illustrates an example of alert display. Note that, in FIG. 9, portions corresponding to those in the case of FIG. 3 are denoted by the same reference signs, and the description thereof will be omitted as appropriate.

In FIG. 9, in the frequency characteristic display screen similar to that in the case of FIG. 3, the masking combined value (combined masking frequency characteristics) indicated by the curve L13 exceeds the set upper limit value in a frequency band on a low frequency side.

Thus, in this example, an alert AL11 is displayed for the frequency band exceeding the upper limit value. The alert AL11 is a straight line indicating an upper limit value set for the frequency band. In the portion of the alert AL11, the masking combined value illustrated in the curve L13 is located above the straight line that is the alert AL11, and the user can visually understand in which frequency band and how much the masking combined value is greater than the upper limit value.

Note that the alert display in a case where the masking combined value exceeds the upper limit value is not limited to the example of FIG. 9, and may be any display. Furthermore, the user may be notified of the alert by means of voice, vibration, or the like instead of the alert display, or notification to the user may be performed by combining the alert display with any means of voice, vibration, or the like.

Furthermore, the method of setting the upper limit value by the user may be any method such as a method of directly inputting the upper limit value or a method of setting the upper limit value by a GUI.

Specifically, for example, the upper limit value may be set like a graphical equalizer (EQ) by moving a GUI displayed on the display unit 23 by the user operating the input unit 21, that is, a bar representing the upper limit value on the setting screen.

Furthermore, the information processing apparatus 11 may perform music analysis or the like on the basis of the audio signal of the object, and automatically set the upper limit value on the basis of an analysis result of a genre, a melody, or the like of content obtained as a result of the music analysis or the like, without depending on the user's operation or the like.

For example, regarding an object of Vocal (vocal), an important frequency band for Vocal can be automatically discriminated on the basis of the analysis result, and it is possible to set the upper limit value on the basis of the determination result. Similarly, regarding an object of Guitar (guitar), an important frequency band of Guitar can be automatically discriminated on the basis of the analysis result, and it is possible to set the upper limit value on the basis of the discrimination result.

### <Configuration Example of Information Processing Apparatus>

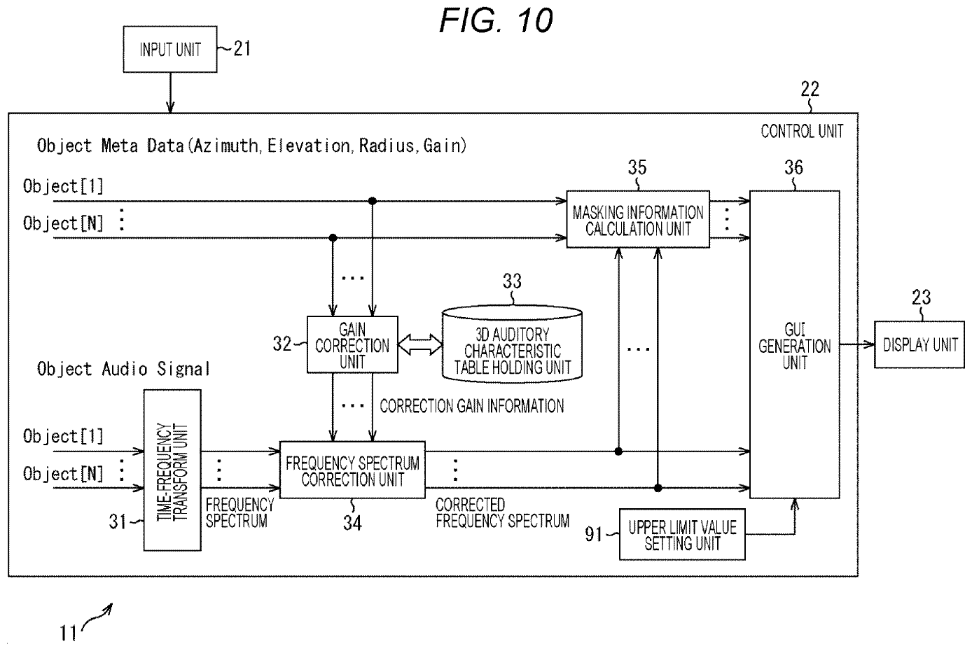

In a case where the information processing apparatus 11 sets the upper limit value of the masking combined value, the information processing apparatus 11 is configured as illustrated in FIG. 10, for example. Note that, in FIG. 10, portions corresponding to those in the case of FIG. 1 are denoted by the same reference signs, and the description thereof will be omitted as appropriate.

The configuration of the information processing apparatus 11 illustrated in FIG. 10 is different from the configuration illustrated in FIG. 1 in that an upper limit value setting unit 91 is newly provided in the control unit 22, and is the same as the example illustrated in FIG. 1 in other points.

The upper limit value setting unit 91 sets the upper limit value of the masking combined value for the object, and supplies the setting result to the GUI generation unit 36.

### <Description of GUI Display Processing>

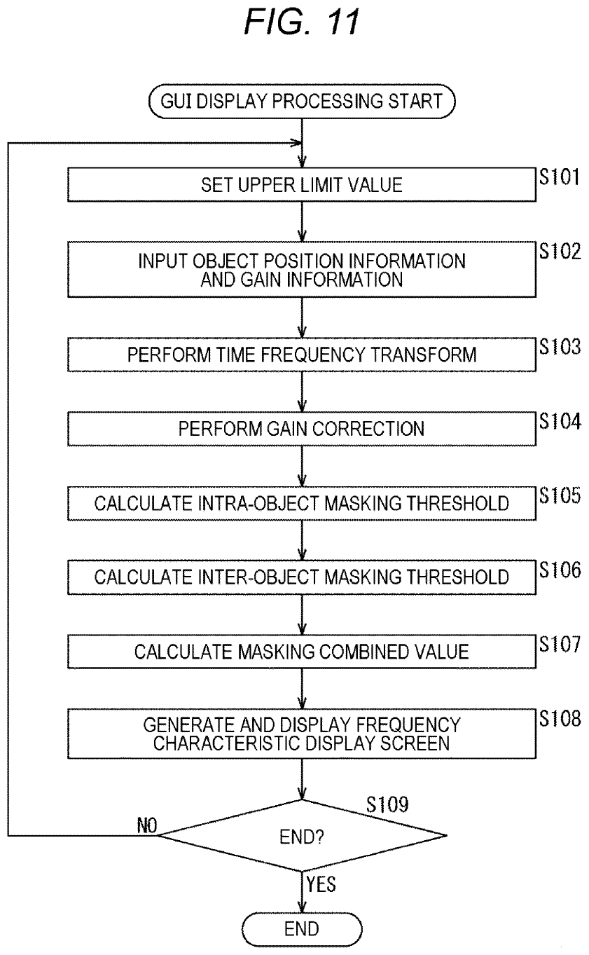

Next, GUI display processing performed by the information processing apparatus 11 illustrated in FIG. 10 will be described with reference to a flowchart in FIG. 11.

In step S101, the upper limit value setting unit 91 sets the upper limit value of the masking combined value for the object, and supplies the setting result to the GUI generation unit 36.

For example, in a case where the user performs an operation of setting the upper limit value by operating the input unit 21, the upper limit value setting unit 91 sets the upper limit value for each object or each frequency on the basis of a signal supplied from the input unit 21 according to the setting operation.

Furthermore, for example, the upper limit value setting unit 91 performs music analysis on an audio signal of content obtained by adding supplied audio signals of all the objects, and sets the upper limit value for each object or each frequency on the basis of the analysis result.

After the upper limit value is set, processing of steps S102 to S109 is performed and the GUI display processing ends, but since the processing is similar to the processing of steps S11 to S18 of FIG. 4, the description thereof will be omitted.

However, in step S108, the GUI generation unit 36 determines whether or not the masking combined value obtained for the target object exceeds the upper limit value on the basis of the upper limit value supplied from the upper limit value setting unit 91 in step S101, and generates the frequency characteristic display screen according to the determination result.

Specifically, in a case where it is determined that there is no masking combined value exceeding the upper limit value, the GUI generation unit 36 generates image data for displaying the frequency characteristic display screen without alert display as illustrated in FIG. 3, for example, and supplies the image data to the display unit 23.

On the other hand, in a case where it is determined that there is a masking combined value exceeding the upper limit value, the GUI generation unit 36 generates image data for displaying the frequency characteristic display screen with alert display as illustrated in FIG. 9, for example, and supplies the image data to the display unit 23.

As described above, the information processing apparatus 11 generates the image data of the frequency characteristic display screen according to the presence or absence of the masking combined value exceeding the upper limit value, and displays the frequency characteristic display screen.

In this way, the user can more easily visually understand the effect of the auditory masking between the objects. As a result, the number of times of listening confirmation required in the process of repeating the adjustment of the object position information and the gain information can be reduced, and the 3D audio content can be produced in a shorter time.

### Fourth Embodiment

### <Display of Object Movement Destination Candidates>

For example, in a case where there is an object in which the masking combined value exceeds the upper limit value that is the set allowable amount, the masking combined value may be prevented from exceeding the upper limit value by changing the position of the object or the position of another object in the three-dimensional space.

Accordingly, in a case where there is an object of which the masking combined value exceeds the upper limit value, a candidate for the position of the object (a candidate for the position of the change destination) and a candidate for the position of another object of which the masking combined value does not exceed the upper limit value may be obtained by analysis or the like, and the obtained candidate may be displayed on the GUI. When the candidate for the position is presented, in addition to the place where the masking combined value does not exceed the upper limit value, the arrangement that does not cause the user to feel uncomfortable in audibility may be selected and displayed according to the type of the object or the type of the content.

Moreover, for example, for a plurality of grouped objects such as stem data, candidate destinations for moving the entire group including the plurality of objects may be simultaneously displayed in the GUI.

In such a case, for example, a constraint in consideration of the object positional relationship may be added to the candidate destination, such as maintaining a bilaterally symmetric positional relationship of each object or moving the objects in parallel while maintaining the angle between the objects.

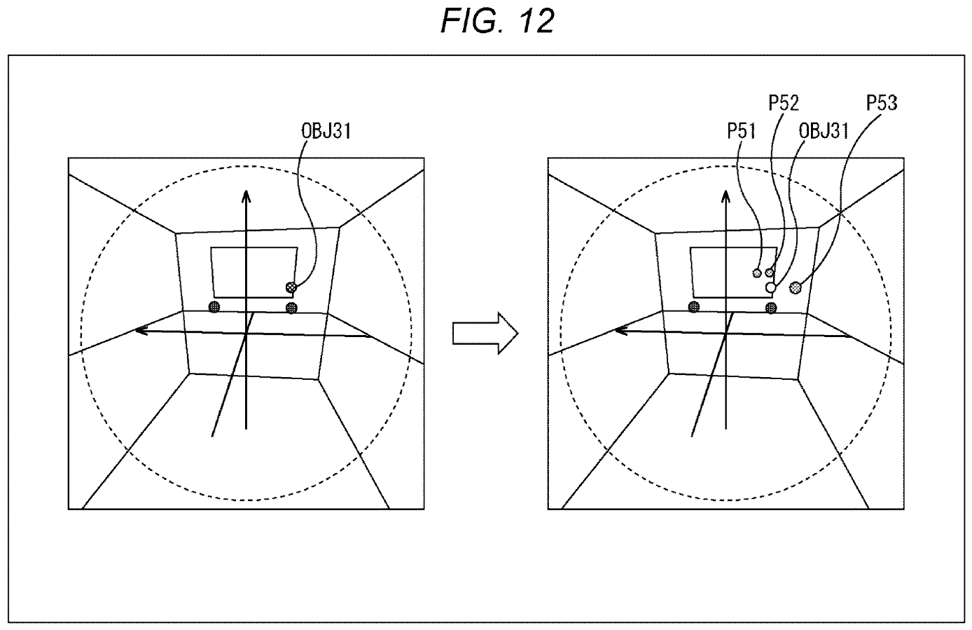

FIG. 12 illustrates a display example of candidates for the movement destination of the position of the object.

For example, it is assumed that the screen illustrated on the left side of FIG. 12 is displayed on the display unit 23. In this example, a three-dimensional space is illustrated on the display screen, and a plurality of objects including an object OBJ31 is arranged in the three-dimensional space. In particular, one sphere represents one object here.

For example, it is assumed that the object OBJ31 is the target object, and the masking combined value exceeds the upper limit value at the arrangement position of the object OBJ31 illustrated on the left side in the drawing.

In such a case, the masking information calculation unit 35 obtains a candidate for the position of the object OBJ31 so that the masking combined value does not exceed the upper limit value, that is, a candidate for the movement destination of the object OBJ31, and the obtained position of the candidate is displayed.

Thus, the display of the display unit 23 is updated, for example, from the display illustrated on the left side in the drawing to the display illustrated on the right side in the drawing.

In the example illustrated on the right side in the drawing, positions P51 to P53 are displayed as candidates for the movement destination of the object OBJ31. The user can designate any one of these three positions P51 to P53 as the position of the movement destination of the object OBJ31 by operating the input unit 21.

When a predetermined candidate is designated as the position of the movement destination by the user, thereafter, the object position information of the object OBJ31 is updated (changed) so that the position indicated by the object position information becomes the position designated by the user.

Note that, although an example in which three candidates are displayed as the candidates for the movement destination of the object has been described here, the number of displayed candidates may be any number.

### <Description of GUI Display Processing>

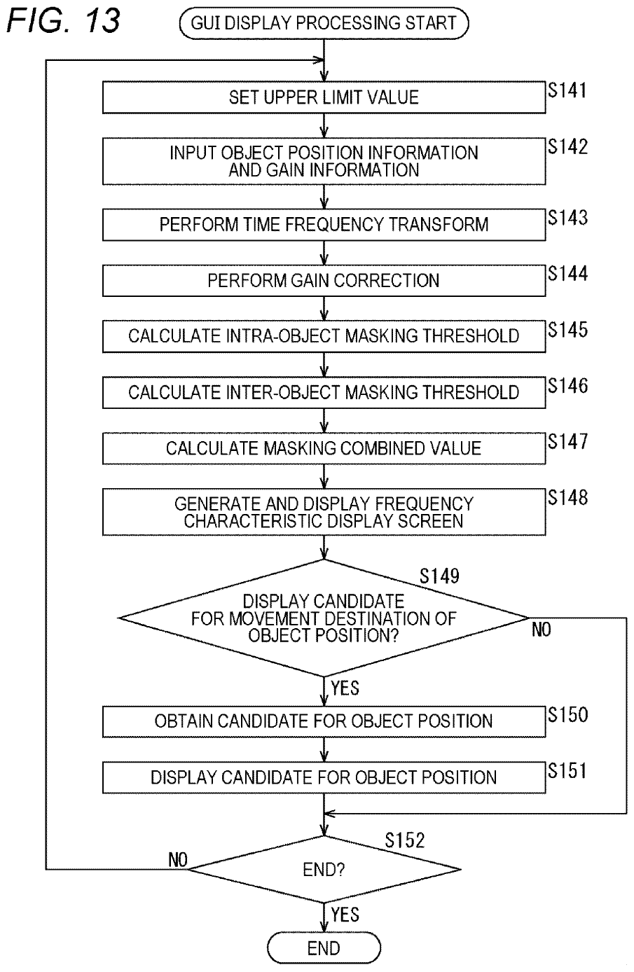

In a case where candidates for a movement destination of the object are displayed, the information processing apparatus 11 illustrated in FIG. 10 performs GUI display processing illustrated in FIG. 13. Hereinafter, the GUI display processing by the information processing apparatus 11 will be described with reference to a flowchart of FIG. 13.

Note that processing of steps S141 to S148 is similar to the processing of steps S101 to S108 in FIG. 11, and thus the description thereof will be omitted.

In step S149, the GUI generation unit 36 determines whether or not to display the object position information, that is, candidates for the movement destination of the object position in the three-dimensional space.

For example, in step S149, in a case where there is a masking combined value of the target object exceeding the upper limit value, it is determined that the candidates for the movement destination of the object position are to be displayed.

In addition, for example, in a case where there is a masking combined value of the target object exceeding the upper limit value, and the user instructs display of candidates for the movement destination of the object position by operating the input unit 21, it may be determined to display the candidates for the movement destination of the object position.

In a case where it is determined in step S149 that the candidates for the movement destination the object position are not to be displayed, the processing of steps S150 and S151 is skipped, and thereafter, the processing proceeds to step S152.

On the other hand, in a case where it is determined in step S149 that the candidates for the movement destination of the object position are to be displayed, the processing of step S150 is then performed.

In step S150, the masking information calculation unit 35 calculates a masking combined value for the target object while changing the object position information of a predetermined object, thereby obtaining a candidate for the movement destination of the object position.

Specifically, the masking information calculation unit 35 performs processing similar to that of steps S15 and S16 in FIG. 4 on the basis of the corrected frequency spectrum and the object position information of each object while changing the object position information of the predetermined object.

Then, on the basis of the upper limit value supplied from the upper limit value setting unit 91, the masking information calculation unit 35 specifies an object position of the predetermined object where the masking combined value does not exceed the upper limit value, and sets the specified object position as an object position that is a candidate for the movement destination.

At this time, the predetermined object whose object position information is changed may be the target object, or may be a designated other object, a predetermined number of objects at the closest distance from the target object, an object designated by the user, or the like.

Furthermore, the number of object positions (hereinafter, it is also referred to as candidate positions) that are candidates for the movement destination may be one or plural. In a case where there is only one candidate position, for example, among the object positions where the masking combined value does not exceed the upper limit value, the position closest to the object position originally designated in the processing of step S142 is set as a candidate position. In addition, the candidate position of the movement destination may be obtained for a plurality of objects.

The masking information calculation unit 35 supplies the obtained candidate for the movement destination of the object position, that is, the object position information indicating the candidate position to the GUI generation unit 36.

In step S151, the GUI generation unit 36 causes the display unit 23 to display the candidate position supplied from the masking information calculation unit 35, that is, the candidate for the movement destination of the object position.

That is, the GUI generation unit 36 generates image data for displaying a candidate position display screen that visually presents candidate positions in the three-dimensional space on the basis of the object position information indicating one or more candidate positions.

For example, when there is a plurality of candidate positions for one object, a region including the plurality of candidate positions for the object in the three-dimensional space may be displayed on the candidate position display screen.

The GUI generation unit 36 supplies the generated image data to the display unit 23 to cause the display unit 23 to display the candidate position display screen. Thus, for example, the screen illustrated on the right side of FIG. 12 is displayed. In this case, display is performed so that which candidate for the movement destination of the object is presented and the position of the object before and after the movement can be easily grasped.

Note that the candidate position display screen may be displayed on the frequency characteristic display screen, or may be displayed as a screen separate from the frequency characteristic display screen.

In a case where the processing of step S151 is performed and the candidate position display screen is displayed or it is determined in step S149 that no candidate is to be displayed, thereafter, the processing proceeds to step S152.

In step S152, the control unit 22 determines whether or not to end the mixing, that is, the processing of adjusting the object position information and the gain information.

In a case where it is determined not to end the processing yet in step S152, thereafter, the processing returns to step S141, and the above-described processing is repeatedly performed.

In this case, in a case where the upper limit value is not particularly changed, the processing of step S141 is not performed. Furthermore, for example, in step S142, the user may be allowed to designate a candidate position on the candidate position display screen by operating the input unit 21, to thereby instruct input of the object position information, that is, change of the object position information.

On the other hand, in a case where it is determined in step S152 to end the processing, the control unit 22 generates metadata of each object including the designated object position information and gain information and records the metadata in the recording unit, which is not illustrated, and the GUI display processing ends.

As described above, the information processing apparatus 11 appropriately obtains candidates for the object position and displays the candidate position display screen.

In this way, the user can visually understand the object position that does not exceed the upper limit value. Therefore, the number of times of trial listening confirmation required in the process of repeating the adjustment of the object position information and the gain information can be further reduced, and the 3D audio content can be produced in a shorter time.

### Fifth Embodiment

### <Configuration Example of Encoder>

Furthermore, the present technology is also applicable to a 3D audio encoder (hereinafter, it is also simply referred to as an encoder).

For example, an object or frequency band in which an upper limit value of the allowable masking combined value described above is set is considered to be an important object or frequency band that is not desired to be masked from other objects.

Accordingly, such setting information regarding allowable spatial masking may be used at the time of bit allocation of the encoder.

The setting information is information regarding a masking threshold of the important object or frequency that is not desired to be masked from other objects. For example, the setting information includes an object ID indicating an object for which an allowable masking threshold, that is, an upper limit value of a masking combined value (masking threshold) is set, information indicating a frequency for which the upper limit value is set, information indicating a set upper limit value (allowable masking threshold), and the like.

That is, for example, in the setting information, an allowable masking threshold (an upper limit value of an allowable masking combined value) is set for each frequency for each object.

In this way, it is possible to preferentially allocate bits to objects and frequencies that are considered important by the mixing engineer to increase a sound quality ratio over other objects and frequencies, thereby improving the sound quality of the entire content and improving encoding efficiency.

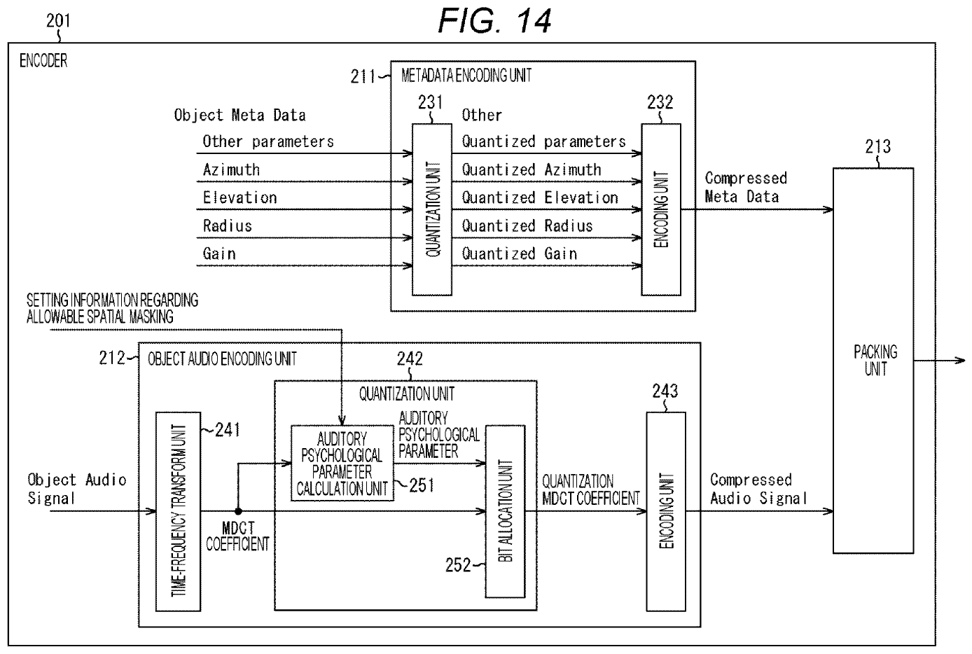

FIG. 14 is a diagram illustrating a configuration example of an encoder to which the present technology is applied.

The encoder 201 illustrated in FIG. 14 includes, for example, a signal processing apparatus such as a computer that functions as an encoder (encoding apparatus).

For example, in the encoder 201, the setting information is included in a part of content data in the form of object metadata, configuration information, or the like, and is input together with an audio signal or metadata at the time of encoding.

The encoder 201 includes a metadata encoding unit 211, an object audio encoding unit 212, and a packing unit 213.

The metadata encoding unit 211 encodes the supplied metadata of each of the plurality of objects in accordance with, for example, the Moving Picture Experts Group (MPEG)-H standard or the like, and supplies encoded metadata obtained as a result to the packing unit 213.

In this example, a horizontal angle (Azimuth), a vertical angle (Elevation), a distance (Radius), gain information (Gain), and other parameters are input to the metadata encoding unit 211 as parameters constituting the metadata.

In particular, information including a horizontal angle, a vertical angle, and a distance is the object position information, and other parameters are parameters for spread processing for spreading a sound image, priority of an object, and the like. Note that the parameters input as metadata is not limited to parameters expressed in the polar coordinate format such as a horizontal angle (Azimuth), a vertical angle (Elevation), and a distance (Radius) described above, and may be a parameter expressed in the XYZ format, for example.

The metadata encoding unit 211 includes a quantization unit 231 and an encoding unit 232, and the metadata of each object is input to the quantization unit 231.

The quantization unit 231 quantizes the input (supplied) metadata and supplies a quantization parameter obtained as a result to the encoding unit 232. The encoding unit 232 encodes the quantization parameter supplied from the quantization unit 231, and supplies encoded metadata obtained as a result to the packing unit 213.

The object audio encoding unit 212 encodes the supplied audio signal of each object according to, for example, the MPEG-H standard, and supplies the encoded audio signal obtained as a result to the packing unit 213.

The object audio encoding unit 212 includes a time-frequency transform unit 241, a quantization unit 242, and an encoding unit 243.

The time-frequency transform unit 241 performs time-frequency transform using the MDCT on the supplied audio signal of each object, and supplies an MDCT coefficient, which is frequency spectrum information of each object obtained as a result, to the quantization unit 242.

The quantization unit 242 quantizes the MDCT coefficient supplied from the time-frequency transform unit 241, and supplies quantized frequency spectrum information obtained as a result, that is, a quantized MDCT coefficient, which is quantized frequency spectrum information, to the encoding unit 243.

The quantization unit 242 includes an auditory psychological parameter calculation unit 251 and a bit allocation unit 252.

On the basis of the supplied setting information and the MDCT coefficient supplied from the time-frequency transform unit 241, the auditory psychological parameter calculation unit 251 calculates an auditory psychological parameter for considering human auditory characteristics (auditory masking), and supplies the auditory psychological parameter to the bit allocation unit 252.

The bit allocation unit 252 performs bit allocation processing on the basis of the MDCT coefficient supplied from the time-frequency transform unit 241 and the auditory psychological parameter supplied from the auditory psychological parameter calculation unit 251.

In the bit allocation processing, bit allocation based on an auditory psychological model, in which quantization bits and quantization noise of each scale factor band are calculated and evaluated, is performed. Then, the MDCT coefficient is quantized for each scale factor band on the basis of the result of the bit allocation, and a quantized MDCT coefficient is obtained (generated).

The bit allocation unit 252 supplies the quantized MDCT coefficient for each scale factor band of each object obtained in this manner to the encoding unit 243 as a quantization result of each object, more specifically, as a quantization result of the MDCT coefficient of each object.

Here, the scale factor band is a band (frequency band) obtained by bundling a plurality of subbands (here, resolution of MDCT) with a predetermined bandwidth on the basis of the human auditory characteristics.

Through the bit allocation processing as described above, a part of quantized bits of a scale factor band in which the quantization noise that is generated in quantization of the MDCT coefficient is masked and is not perceived is allocated (assigned) to a scale factor band in which the quantization noise is easily perceived. At this time, bits are preferentially allocated to the important object and frequency (scale factor band), according to the setting information. In other words, the bits are appropriately allocated to an object and a frequency, to which an upper limit value is set, according to the upper limit value.

Thus, it is possible to suppress deterioration in overall sound quality, particularly deterioration in sound quality of objects and frequencies that the user (mixing engineer) considers to be important, and to perform efficient quantization. That is, encoding efficiency can be improved.

In particular, in calculating the quantized MDCT coefficient, the auditory psychological parameter calculation unit 251 calculates a masking threshold (auditory psychological parameter) for each frequency for each object on the basis of the setting information. Then, at the time of the bit allocation processing in the bit allocation unit 252, quantization bits are allocated so that quantization noise does not exceed the masking threshold.

For example, at the time when the auditory psychological parameter is calculated, parameter adjustment is performed on the frequency to which the upper limit value is set according to the setting information, so as to reduce the allowable quantization noise, and the auditory psychological parameter is calculated.

Note that an adjustment amount of the parameter adjustment may change according to the allowable masking threshold indicated by the setting information, that is, the upper limit value. Therefore, it is possible to allocate more bits to the frequency.

The encoding unit 243 encodes the quantized MDCT coefficient for each scale factor band of each object supplied from the bit allocation unit 252, and supplies the encoded audio signal obtained as a result to the packing unit 213.

The packing unit 213 packs the encoded metadata supplied from the encoding unit 232 and the encoded audio signal supplied from the encoding unit 243, and outputs the encoded bit stream obtained as a result.

### <Description of Encoding Process>

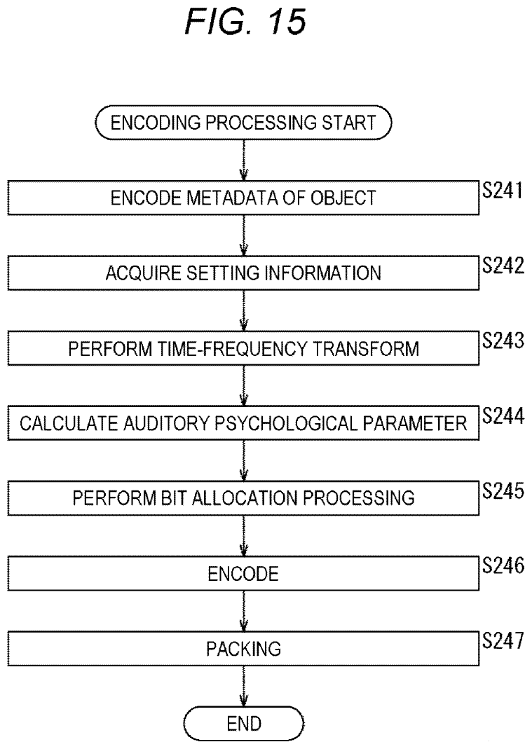

Next, an operation of the encoder 201 will be described. That is, encoding processing by the encoder 201 will be described below with reference to a flowchart in FIG. 15.

In step S241, the metadata encoding unit 211 encodes the metadata of each object, and supplies the encoded metadata obtained as a result to the packing unit 213.

That is, the quantization unit 231 quantizes the supplied metadata of each object and supplies the quantization parameter obtained as a result to the encoding unit 232. Furthermore, the encoding unit 232 encodes the quantization parameter supplied from the quantization unit 231, and supplies encoded metadata obtained as a result to the packing unit 213.

In step S242, the auditory psychological parameter calculation unit 251 acquires the setting information.

In step S243, the time-frequency transform unit 241 performs the time-frequency transform using the MDCT on the supplied audio signal of each object, and generates the MDCT coefficient for each scale factor band. The time-frequency transform unit 241 supplies the generated MDCT coefficient to the auditory psychological parameter calculation unit 251 and the bit allocation unit 252.

In step S244, the auditory psychological parameter calculation unit 251 calculates the auditory psychological parameter on the basis of the setting information acquired in step S242 and the MDCT coefficient supplied from the time-frequency transform unit 241, and supplies the same to the bit allocation unit 252.

At this time, for the object and the frequency (scale factor band) indicated by the setting information, the auditory psychological parameter calculation unit 251 calculates the auditory psychological parameter on the basis of the upper limit value indicated by the setting information so as to reduce the allowable quantization noise.

In step S245, the bit allocation unit 252 performs the bit allocation processing on the basis of the MDCT coefficient supplied from the time-frequency transform unit 241 and the auditory psychological parameter supplied from the auditory psychological parameter calculation unit 251.

The bit allocation unit 252 supplies the quantized MDCT coefficient obtained by the bit allocation processing to the encoding unit 243.

In step S246, the encoding unit 243 encodes the quantized MDCT coefficient supplied from the bit allocation unit 252, and supplies the encoded audio signal obtained as a result to the packing unit 213.

For example, the encoding unit 243 performs context-based arithmetic encoding on the quantized MDCT coefficient, and outputs the encoded quantized MDCT coefficient to the packing unit 213 as the encoded audio signal. Note that the encoding method is not limited to arithmetic coding, and may be any other encoding method including a Huffman coding method, other encoding methods, or the like.

In step S247, the packing unit 213 packs the encoded metadata supplied from the encoding unit 232 and the encoded audio signal supplied from the encoding unit 243, and outputs the encoded bit stream obtained as a result. If the encoded bit stream obtained by packing is output, the encoding processing ends.

As described above, the encoder 201 calculates the auditory psychological parameter on the basis of the setting information and performs the bit allocation processing. In this way, it is possible to increase the bit allocation for an object or a sound in a frequency band that the content creator, that is, the mixing engineer wants to prioritize, and encoding efficiency can be improved.

### Sixth Embodiment

### <Other Application Examples>

Incidentally, specifying of an arrival direction of an external sound can be performed by using a plurality of microphones with headphones or earphones.

Moreover, when sound is reproduced with headphones or earphones, adjusting of the sound image position of the reproduced sound can be performed by subjecting the reproduced sound to signal processing such as a head related transfer function (HRTF) or EQ/panning.

By combining the specifying of the arrival direction of the external sound and the adjusting of the sound image position of the reproduced sound, it is difficult to hear the sound in a case where the external sound and the reproduced sound are in the same direction or in a direction in which the masking becomes strong, but it is possible to improve the hearing by moving the sound image position of the reproduced sound to a position in which the masking becomes weak. Furthermore, even in a case of using a hearing aid such as an acoustic aid or a sound pickup device, the sound image position can be adjusted when amplifying and reproducing the voice of a person who is speaking in front with the hearing aid.

In such a case, there is an individual difference in a position where masking becomes weak and hearing becomes good, and adjustment is required for each individual in order to enhance the effect. Accordingly, a function of easily checking a direction in which the masking position becomes weak and adjusting the hearing aid is required.

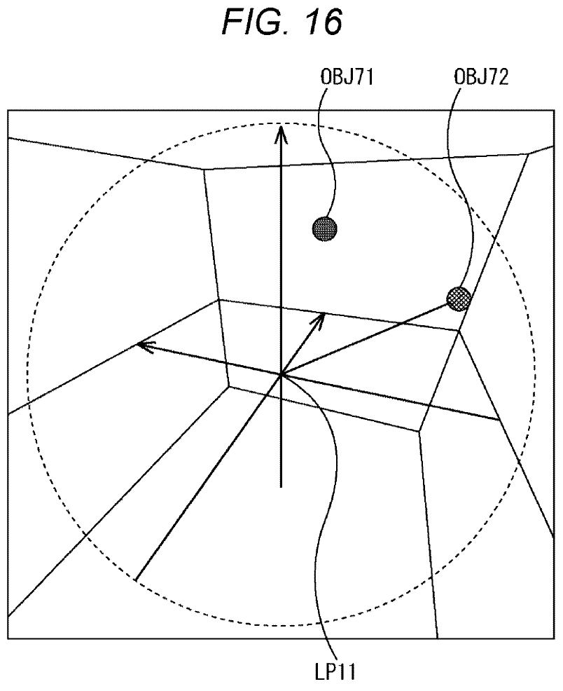

For example, as illustrated in FIG. 16, it is assumed that an object OBJ71 of an external sound (noise) is arranged in a front direction with respect to a listening position LP11 in a three-dimensional space, and an object OBJ72 of a sound desired to be heard (target sound) such as a voice or a dangerous sound is arranged obliquely right forward.

That is, in the hearing aid worn by the user, an external sound (noise) is reproduced in the direction of the object OBJ71 in the front direction as viewed from the user (listener) at the listening position LP11. In other words, it is assumed that the external sound comes from the direction of the object OBJ71.

Furthermore, it is assumed that, in the hearing aid worn by the user, a sound (target sound) desired to be heard is reproduced in the direction of the object OBJ72 obliquely right forward as viewed from the user at the listening position LP11.

In such a case, for example, there may be an application program that can search for a position of the object OBJ72 at which the target sound is most easily heard for the user by moving the arrangement position of the object OBJ72 corresponding to the target sound represented by a sphere (ball).

Here, for example, it is conceivable that the user can adjust the arrangement position of the object OBJ72 corresponding to the target sound on a reproduction position adjustment screen by an application program operating on a smartphone, a tablet, a personal computer, or the like.

In this case, the user adjusts the arrangement position of the object OBJ72, for example, by touching the reproduction position adjustment screen with a finger or operating a mouse or the like.

Furthermore, an external sound (non-target sound) and an arrival direction of a target sound corresponding to the object OBJ71 and the object OBJ72 can be reproduced by signal processing using an HRTF or the like.

As described above, in a case where the object OBJ71 corresponding to the external sound is arranged at various positions in the three-dimensional space, it is possible to search for an arrangement position of the object OBJ72 of the target sound at which the user who is the hearing aid user can most easily hear the target sound that the user wants to hear, and set the arrangement position in the hearing aid device. In this way, the arrival direction of the external sound is estimated at the time of actual use of the hearing aid, and the sound image position of the sound (target sound) to be heard such as a voice is arranged at the set position which is hard to be masked according to the estimation result, so that the target sound can be more easily heard.

In such a case, for example, in the information processing apparatus 11 illustrated in FIG. 1, the control unit 22 controls the display unit 23 to display the reproduction position adjustment screen illustrated in FIG. 16. At this time, the control unit 22 controls the display unit 23 to move the arrangement position of the object OBJ72 of the target sound on the reproduction position adjustment screen (three-dimensional space) on the basis of the signal according to the user's operation supplied from the input unit 21.

Furthermore, the control unit 22 generates and records arrangement setting information including position information indicating the arrangement position of the external sound (object OBJ71) and position information indicating the arrangement position of the target sound (object OBJ72) for each arrangement position of the external sound according to the signal according to an operation of the user supplied from the input unit 21. In other words, the arrangement position information is information indicating the arrival direction of the external sound and the direction in which the target sound is easily heard, that is, the arrival direction of the target sound which is easily heard and which is set by the user with respect to the arrival direction of the external sound.

Note that, in generating the arrangement setting information, a frequency characteristic display screen or the like for the target sound and the external sound may be appropriately displayed on the display unit 23. Furthermore, the control unit 22 may generate an audio signal in which an external sound at a sound image position corresponding to the arrangement position of the object OBJ71 and a target sound at a sound image position corresponding to the arrangement position of the object OBJ72 are reproduced, supply the audio signal to a speaker, which is not illustrated, and reproduce the external sound and the target sound.

The control unit 22 outputs the generated arrangement setting information to the hearing aid connected to the information processing apparatus 11, and the arrangement setting information supplied from the information processing apparatus 11 is appropriately used in the hearing aid. The supply of the arrangement setting information from the information processing apparatus 11 to the hearing aid may be performed via a network or another apparatus.

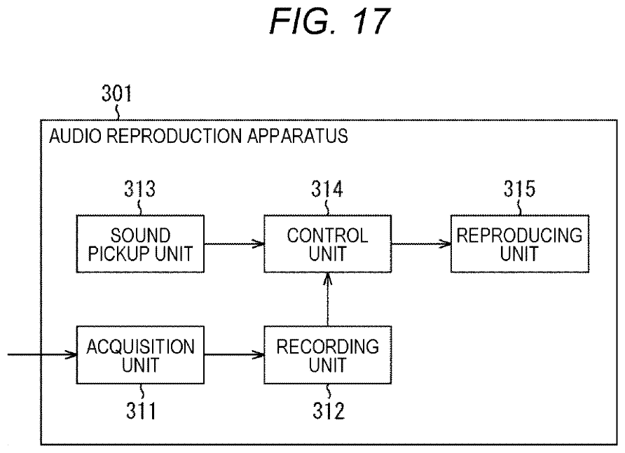

An audio reproducing apparatus that functions as a hearing aid using the arrangement setting information supplied from the information processing apparatus 11 is configured as illustrated in FIG. 17, for example.

An audio reproducing apparatus 301 illustrated in FIG. 17 includes an acquisition unit 311, a recording unit 312, a sound pickup unit 313, a control unit 314, and a reproducing unit 315. The audio reproducing apparatus 301 may be an earphone, a headphone, or the like, or a hearing aid such as an acoustic aid or a sound pickup device.

The acquisition unit 311 acquires the arrangement setting information from an external device such as the information processing apparatus 11, supplies the arrangement setting information to the recording unit 312, and records the arrangement setting information.

The recording unit 312 records various data such as the arrangement setting information and the HRTF supplied from the acquisition unit 311, and appropriately supplies the recorded data to the control unit 314.

The sound pickup unit 313 includes, for example, one or more microphone units, collects ambient sounds including external sounds and target sounds, and supplies a sound collection signal obtained as a result to the control unit 314.

The control unit 314 generates a reproduction signal in which sound is amplified on the basis of a sound pickup signal supplied from the sound pickup unit 313, and supplies the reproduction signal to the reproducing unit 315.

At this time, for example, the control unit 314 performs signal processing based on the sound pickup signal, such as sound source separation and arrival direction estimation for the sound pickup signal, and reads arrangement setting information corresponding to the estimation result of the arrival direction of an external sound from the recording unit 312. That is, the arrangement setting information in which the direction of the position indicated by the position information of the external sound is the same direction as the arrival direction estimation result is read.

In this case, processing of estimating the arrival direction of the external sound on the basis of at least the sound pickup signal is performed as the signal processing. In addition, processing such as sound source separation for extracting a signal of an external sound and a signal of a target sound from the sound pickup signal, hearing aid processing, and the like may be performed.

From the read arrangement setting information, it is possible to specify the arrangement position of the target sound that is less likely to be masked and is set by the user with respect to the estimated arrival direction of the external sound, that is, the arrival direction of the target sound (hereinafter, also referred to as a set arrival direction).

The control unit 314 reads an HRTF for the set arrival direction from the recording unit 312, for example, and generates a reproduction signal by performing the signal processing on the basis of the read HRTF and the sound pickup signal, more specifically, the signal of the target sound obtained from the sound pickup signal. Note that the process of adjusting the arrival direction (sound image position) of the target sound performed when generating the reproduction signal is not limited to the process using the HRTF, and may be any process such as EQ/panning.

The reproduction signal obtained in this manner is an audio signal in which the sound image of the target sound is localized in the direction (set arrival direction) in which the target sound is easily heard, which is indicated by the arrangement setting information corresponding to the estimation result of the arrival direction of the external sound, that is, an audio signal in which the target sound is heard from the set arrival direction. Therefore, by reproducing the sound on the basis of the reproduction signal, the target sound is less likely to be masked by the external sound, and the target sound can be more easily heard.

The reproducing unit 315 includes, for example, a speaker unit, and reproduces (outputs) a sound on the basis of the reproduction signal supplied from the control unit 314.

According to the audio reproducing apparatus 301 as described above, the target sound can be made easier to hear regardless of the arrival direction of the external sound.

### <Configuration Example of Computer>

Incidentally, the above-described series of processing can be executed by hardware or software. In a case where a series of processing is executed by the software, a program forming the software is installed on a computer. Here, examples of the computer include a computer incorporated in dedicated hardware, and a general-purpose personal computer capable of executing various functions by installing various programs or the like.

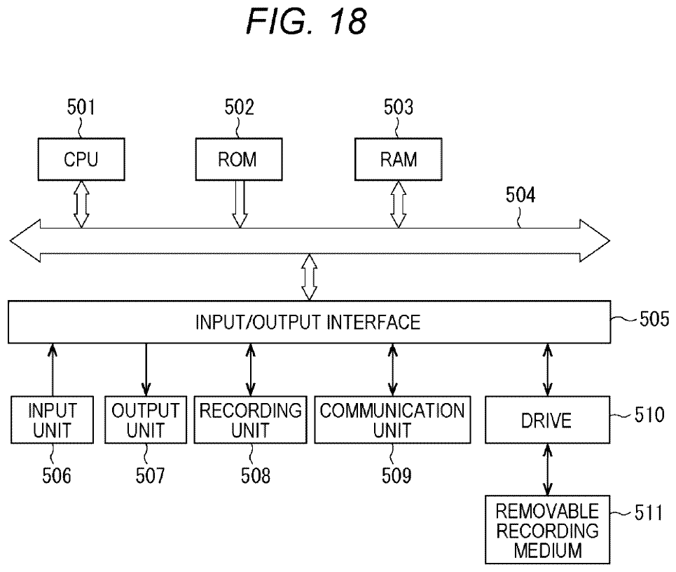

FIG. 18 is a block diagram illustrating a configuration example of the hardware of the computer that executes the series of processing described above in accordance with the program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an image sensor, or the like. The output unit 507 includes a display, a speaker, and the like. The recording unit 508 includes a hard disk, a non-volatile memory and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program, so as to perform the above-described series of processing.

The program executed by the computer (CPU 501) can be provided by being recorded on the removable recording medium 511 as a package medium and the like, for example. Furthermore, the program can be provided via a wired or wireless transmission medium such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program for processing in time series in the order described in the present description, or a program for processing in parallel or at a necessary timing such as when a call is made.

Furthermore, the embodiments of the present technology are not limited to the above-described embodiments, and various modifications can be made without departing from the scope of the present technology.

For example, the present technology can have a configuration of cloud computing in which one function is shared and processed in cooperation by a plurality of devices via a network.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner.

Moreover, the present technology may also have following configurations.

(1)

An information processing apparatus including:
a masking information calculation unit that calculates, as an inter-object masking frequency characteristic, an auditory masking amount at each frequency of a target object with one or more other objects on the basis of a frequency spectrum and object position information of the target object, and the frequency spectrum and the object position information of the one or more other objects different from the target object; and
a display control unit that displays the frequency spectrum of the target object and the inter-object masking frequency characteristic.
   (2)

The information processing apparatus according to (1), in which
the masking information calculation unit calculates, as a combined masking frequency characteristic, a combined value for each frequency of the auditory masking amount between the target object and each of a plurality of the other objects, and
the display control unit further displays the combined masking frequency characteristic of the target object.
   (3)

The information processing apparatus according to (2), in which
the masking information calculation unit
   calculates an auditory masking amount of each frequency in the target object on the basis of the frequency spectrum of the target object, and
   calculates the auditory masking amount between the target object and each of the plurality of the other objects and a combined value of the auditory masking amount for each frequency in the target object as the combined masking frequency characteristic.
      (4)

The information processing apparatus according to (2), in which
in a case where the combined value exceeds a predetermined upper limit value, the display control unit notifies the user that the combined value exceeds the upper limit value.
   (5)

The information processing apparatus according to (4), in which
the upper limit value is set by a user for each of the objects or for each of frequencies.
   (6)

The information processing apparatus according to (4) or (5), further including:
an upper limit value setting unit that sets the upper limit value on the basis of an audio signal of each of one or more objects.
   (7)

The information processing apparatus according to any one of (4) to (6), in which
the masking information calculation unit calculates, in a case where the combined value exceeds the upper limit value, a position that is a candidate for a movement destination of the target object or the other object in a space where the combined value does not exceed the upper limit value, and
the display control unit displays a position that is a candidate for the movement destination of the target object or the other object.
   (8)

The information processing apparatus according to any one of (1) to (7), in which
the masking information calculation unit calculates an auditory masking amount of each frequency in the target object as an intra-object masking frequency characteristic on the basis of the frequency spectrum of the target object, and
the display control unit further displays the intra-object masking frequency characteristic of the target object.
   (9)

The information processing apparatus according to any one of (1) to (8), further including:
a frequency spectrum correction unit that performs gain correction on the frequency spectrum of an object on the basis of gain information of the object to generate a corrected frequency spectrum, in which
the masking information calculation unit calculates the inter-object masking frequency characteristic on the basis of the corrected frequency spectrum and the object position information of the target object, and the corrected frequency spectrum and the object position information of the other object, and
the display control unit displays the corrected frequency spectrum of the target object and the inter-object masking frequency characteristic.
   (10)

The information processing apparatus according to (9), in which
in a case where at least one of the gain information of the target object or the gain information of the other object is changed,
the display control unit displays the corrected frequency spectrum reflecting the change of the target object and the inter-object masking frequency characteristic.
   (11)

The information processing apparatus according to any one of (1) to (8), further including:
a frequency spectrum correction unit that performs gain correction on the frequency spectrum of an object on the basis of a gain correction value determined by the object position information to generate a corrected frequency spectrum, in which
the masking information calculation unit calculates the inter-object masking frequency characteristic on the basis of the corrected frequency spectrum and the object position information of the target object, and the corrected frequency spectrum and the object position information of the other object, and
the display control unit displays the corrected frequency spectrum of the target object and the inter-object masking frequency characteristic.
   (12)

The information processing apparatus according to any one of (1) to (11), in which
in a case where at least one of the object position information of the target object or the object position information of the other object is changed,
the display control unit displays the frequency spectrum reflecting the change of the target object and the inter-object masking frequency characteristic.
   (13)

The information processing apparatus according to any one of (1) to (12), in which
the masking information calculation unit calculates the inter-object masking frequency characteristic based on an acoustic parameter indicating an acoustic characteristic of a space in which the target object and the other object are arranged.
   (14)

The information processing apparatus according to (13), in which
the acoustic parameter used for calculation of the inter-object masking frequency characteristic is the acoustic parameter selected by a user from among a plurality of the acoustic parameters prepared in advance, the acoustic parameter input by the user, or the acoustic parameter calculated on the basis of the actual measurement data selected by the user from among a plurality of pieces of actual measurement data of the acoustic characteristic for each of the spaces.
   (15)

The information processing apparatus according to (13) or (14), in which
the acoustic parameter includes at least one of a size of the space, a shape of the space, or a reflectance of a wall in the space.
   (16)

An information processing method including, by an information processing apparatus:
calculating, as an inter-object masking frequency characteristic, an auditory masking amount at each frequency of a target object with one or more other objects on the basis of a frequency spectrum and object position information of the target object, and the frequency spectrum and the object position information of the one or more other objects different from the target object; and
displaying the frequency spectrum of the target object and the inter-object masking frequency characteristic.
   (17)

A program for causing a computer to execute processing including the steps of:
calculating, as an inter-object masking frequency characteristic, an auditory masking amount at each frequency of a target object with one or more other objects on the basis of a frequency spectrum and object position information of the target object, and the frequency spectrum and the object position information of the one or more other objects different from the target object; and
displaying the frequency spectrum of the target object and the inter-object masking frequency characteristic.
   (18)

An encoding apparatus including:
a time-frequency transform unit that performs time-frequency transform on an audio signal of an object to generate frequency spectrum information;
an auditory psychological parameter calculation unit that calculates an auditory psychological parameter on the basis of the frequency spectrum information and setting information regarding a masking threshold for the object; and
a bit allocation unit that performs the bit allocation processing on the basis of the auditory psychological parameter and the frequency spectrum information to generate quantized frequency spectrum information.
   (19)

An audio reproducing apparatus including:
a recording unit that records arrangement setting information indicating an arrival direction of an external sound and a direction in which a target sound is easily heard with respect to the arrival direction of the external sound;
a sound pickup unit that performs sound pickup of ambient sound;
a control unit that estimates the arrival direction of the external sound on the basis of a sound pickup signal obtained by the sound pickup and generates a reproduction signal in which a sound image of the target sound is localized in a direction in which the target sound indicated by the arrangement setting information corresponding to an estimation result of the arrival direction of the external sound is easily heard on the basis of the sound pickup signal; and
a reproducing unit that reproduces a sound on the basis of the reproduction signal.
   (20)

An information processing apparatus including:
a control unit that
   displays a position adjustment screen indicating an arrangement position of an external sound in a space and an arrangement position of a target sound, moves the arrangement position of the target sound in the space according to an operation of a user,
   reproduces the external sound and the target sound at a sound image position according to the arrangement position, and
   generates arrangement setting information indicating an arrival direction of the external sound and a direction in which the target sound is easily heard and which is set by the user with respect to the arrival direction of the external sound on the basis of the arrangement position of the external sound and the arrangement position of the target sound.

### REFERENCE SIGNS LIST

11 Information processing apparatus
21 Input unit
22 Control unit
23 Display unit
31 Time-frequency transform unit
32 Gain correction unit
33 3D auditory characteristic table holding unit
34 Frequency spectrum correction unit
35 Masking information calculation unit
36 GUI generation unit
61 Reflective object calculation unit
91 Upper limit value setting unit
201 Encoder
212 Object audio encoding unit
213 Packing unit
242 Quantization unit

1. An information processing apparatus comprising:
a masking information calculation unit that calculates, as an inter-object masking frequency characteristic, an auditory masking amount at each frequency of a target object with one or more other objects on a basis of a frequency spectrum and object position information of the target object, and the frequency spectrum and the object position information of the one or more other objects different from the target object; and
a display control unit that displays the frequency spectrum of the target object and the inter-object masking frequency characteristic.

2. The information processing apparatus according to claim 1, wherein
the masking information calculation unit calculates, as a combined masking frequency characteristic, a combined value for each frequency of the auditory masking amount between the target object and each of a plurality of the other objects, and
the display control unit further displays the combined masking frequency characteristic of the target object.

3. The information processing apparatus according to claim 2, wherein
the masking information calculation unit
calculates an auditory masking amount of each frequency in the target object on a basis of the frequency spectrum of the target object, and
calculates the auditory masking amount between the target object and each of the plurality of the other objects and a combined value of the auditory masking amount for each frequency in the target object as the combined masking frequency characteristic.

4. The information processing apparatus according to claim 2, wherein
in a case where the combined value exceeds a predetermined upper limit value, the display control unit notifies the user that the combined value exceeds the upper limit value.

5. The information processing apparatus according to claim 4, wherein
the upper limit value is set by a user for each of the objects or for each of frequencies.

6. The information processing apparatus according to claim 4, further comprising:
an upper limit value setting unit that sets the upper limit value on a basis of an audio signal of each of one or more objects.

7. The information processing apparatus according to claim 4, wherein
the masking information calculation unit calculates, in a case where the combined value exceeds the upper limit value, a position that is a candidate for a movement destination of the target object or the other object in a space where the combined value does not exceed the upper limit value, and
the display control unit displays a position that is a candidate for the movement destination of the target object or the other object.

8. The information processing apparatus according to claim 1, wherein
the masking information calculation unit calculates an auditory masking amount of each frequency in the target object as an intra-object masking frequency characteristic on a basis of the frequency spectrum of the target object, and
the display control unit further displays the intra-object masking frequency characteristic of the target object.

9. The information processing apparatus according to claim 1, further comprising:
a frequency spectrum correction unit that performs gain correction on the frequency spectrum of an object on a basis of gain information of the object to generate a corrected frequency spectrum, wherein
the masking information calculation unit calculates the inter-object masking frequency characteristic on a basis of the corrected frequency spectrum and the object position information of the target object, and the corrected frequency spectrum and the object position information of the other object, and
the display control unit displays the corrected frequency spectrum of the target object and the inter-object masking frequency characteristic.

10. The information processing apparatus according to claim 9, wherein
in a case where at least one of the gain information of the target object or the gain information of the other object is changed,
the display control unit displays the corrected frequency spectrum reflecting the change of the target object and the inter-object masking frequency characteristic.

11. The information processing apparatus according to claim 1, further comprising:
a frequency spectrum correction unit that performs gain correction on the frequency spectrum of an object on a basis of a gain correction value determined by the object position information to generate a corrected frequency spectrum, wherein
the masking information calculation unit calculates the inter-object masking frequency characteristic on a basis of the corrected frequency spectrum and the object position information of the target object, and the corrected frequency spectrum and the object position information of the other object, and
the display control unit displays the corrected frequency spectrum of the target object and the inter-object masking frequency characteristic.

12. The information processing apparatus according to claim 1, wherein
in a case where at least one of the object position information of the target object or the object position information of the other object is changed,
the display control unit displays the frequency spectrum reflecting the change of the target object and the inter-object masking frequency characteristic.

13. The information processing apparatus according to claim 1, wherein
the masking information calculation unit calculates the inter-object masking frequency characteristic based on an acoustic parameter indicating an acoustic characteristic of a space in which the target object and the other object are arranged.

14. The information processing apparatus according to claim 13, wherein
the acoustic parameter used for calculation of the inter-object masking frequency characteristic is the acoustic parameter selected by a user from among a plurality of the acoustic parameters prepared in advance, the acoustic parameter input by the user, or the acoustic parameter calculated on a basis of the actual measurement data selected by the user from among a plurality of pieces of actual measurement data of the acoustic characteristic for each of the spaces.

15. The information processing apparatus according to claim 13, wherein
the acoustic parameter includes at least one of a size of the space, a shape of the space, or a reflectance of a wall in the space.

16. An information processing method comprising, by an information processing apparatus:
calculating, as an inter-object masking frequency characteristic, an auditory masking amount at each frequency of a target object with one or more other objects on a basis of a frequency spectrum and object position information of the target object, and the frequency spectrum and the object position information of the one or more other objects different from the target object; and
displaying the frequency spectrum of the target object and the inter-object masking frequency characteristic.

17. A program for causing a computer to execute processing comprising the steps of:
calculating, as an inter-object masking frequency characteristic, an auditory masking amount at each frequency of a target object with one or more other objects on a basis of a frequency spectrum and object position information of the target object, and the frequency spectrum and the object position information of the one or more other objects different from the target object; and
displaying the frequency spectrum of the target object and the inter-object masking frequency characteristic.

18. An encoding apparatus comprising:
a time-frequency transform unit that performs time-frequency transform on an audio signal of an object to generate frequency spectrum information;
an auditory psychological parameter calculation unit that calculates an auditory psychological parameter on a basis of the frequency spectrum information and setting information regarding a masking threshold for the object; and
a bit allocation unit that performs the bit allocation processing on a basis of the auditory psychological parameter and the frequency spectrum information to generate quantized frequency spectrum information.

19. An audio reproducing apparatus comprising:
a recording unit that records arrangement setting information indicating an arrival direction of an external sound and a direction in which a target sound is easily heard with respect to the arrival direction of the external sound;
a sound pickup unit that performs sound pickup of ambient sound;
a control unit that estimates the arrival direction of the external sound on a basis of a sound pickup signal obtained by the sound pickup and generates a reproduction signal in which a sound image of the target sound is localized in a direction in which the target sound indicated by the arrangement setting information corresponding to an estimation result of the arrival direction of the external sound is easily heard on a basis of the sound pickup signal; and
a reproducing unit that reproduces a sound on a basis of the reproduction signal.

20. An information processing apparatus comprising:
a control unit that
displays a position adjustment screen indicating an arrangement position of an external sound in a space and an arrangement position of a target sound, moves the arrangement position of the target sound in the space according to an operation of a user,
reproduces the external sound and the target sound at a sound image position according to the arrangement position, and
generates arrangement setting information indicating an arrival direction of the external sound and a direction in which the target sound is easily heard and which is set by the user with respect to the arrival direction of the external sound on a basis of the arrangement position of the external sound and the arrangement position of the target sound.
